(19) United States
(12) Patent Application Publication
(10) Pub. No.: US 2014/0245984 A1
(43) Pub. Date: Sep. 4, 2014

(54) MOBILE ASSEMBLY COMPRISING A STARTER DRIVE UNIT AND A CONTROL LEVER, FOR MESHING WITH A STARTER RING GEAR OF A HEAT ENGINE, AND A HEAT ENGINE STARTER COMPRISING SUCH AN ASSEMBLY

(71) Applicants: Guillaume Seillier, La Verpilliere (FR); Christian Mornieux, Oullins (FR); Alexis Chalmet, Lyon (FR)

(72) Inventors: Guillaume Seillier, La Verpilliere (FR); Christian Mornieux, Oullins (FR); Alexis Chalmet, Lyon (FR)

(73) Assignee: Valeo Equipments Electriques Moteur, Creteil Cedex (FR)

(21) Appl. No.: 14/235,395

(22) PCT Filed: Jul. 23, 2012
(86) PCT No.: PCT/FR2012/051746

§ 371 Date: May 5, 2014

(30) Foreign Application Priority Data
Jul. 26, 2011 (FR) 1156805

(51) Int. Cl. F02N 15/08

(52) U.S. Cl. CPC F02N 15/08
USPC 123/185.1

(57) ABSTRACT

Mobile assembly (500) for meshing with a toothed starter ring gear (C) of a heat engine comprises: a drive unit (1) provided with a pinion (11); a starter drive element (118); a pivoting control lever (20) including a lower forked end having two arms; and a friction clutch (300), pinion being rotationally fixed with a casing partially housing the drive element (118) and comprising the reaction plate (112) of the clutch. The lever (20) is associated with means for closing the clutch and is configured to move the casing axially, while the closure means are configured to move the drive element axially in order to tighten the friction clutch. The heat engine starter comprises such a mobile assembly.

### SCOPE OF THE INVENTION

This invention relates to a mobile starter drive unit and control lever assembly for meshing with a starter ring gear of a heat engine, in particular of a motor vehicle.

This invention also relates to a starter for a heat engine, in particular of a motor vehicle, incorporating such an assembly.

### STATE OF THE ART

As may be seen in FIG. 1, which is a view in axial cross-section similar to that in FIG. 1 of document FR 2 787 833, a conventional starter 4 for a heat engine, in particular a motor vehicle engine, comprises:
a casing 18;
an output shaft 24 driven in rotation by casing 18;
a starter drive unit 1 movably mounted on output shaft 24;
a control lever 20 forming a mobile assembly with starter drive unit 1 configured to control the movement of starter drive unit 1 and mesh the latter with a starter ring gear C of the heat engine;
an electric motor M housed in casing 18 fitted with a shaft 26 driving starter drive unit 1;
means for manoeuvring the control lever.

The manoeuvring means may comprise a moving core member 2b configured to act on control lever 20 and cause it to pivot to move starter drive unit 1 (see FIG. 1).

This moving core member 2b may belong to an electromagnetic contactor 2 provided with a body 2d supported by casing 18 and provided with a moving control rod 3/moving contact 3a assembly; this moving core member 2b being configured to act on the moving assembly and move it rearwards in the direction of the heads of fixed electrical contact terminals 3e, 3f to provide electrical power to electric motor M.

Starter ring gear C may comprise an externally toothed ring (FIG. 1) of one piece with a plate rigidly or resiliently connected to the crankshaft of the heat engine as in the case of documents FR 2 631 094 and GB 225 757. As a variant, drive starter ring C may comprise an internally toothed ring gear of one piece with a pulley forming part of a belt drive transmission acting between the pulley and a pulley which is of one piece with the crankshaft as described in document FR 2 858 366.

Output shaft 24 of starter 4 may be combined with the drive shaft 26 of electric motor M as described for example in document GB 225 757, or be separate from that shaft 26; at least one reduction gear 34 being placed between shafts 24, 26 as described in documents FR 2 631 094 and FR 2 858 366.

Reduction gears 34 make it possible to use a faster electric motor and to obtain a higher starting torque while reducing the size and weight of the starter for a given power. These reduction gears 34 are often reduction gear trains, either having an epicycloidal train, in which case shafts 24, 26 are coaxial (see FIG. 1), or internally geared as described in document FR 2 631 094, in which case shafts 24, 26 are radially offset with respect to each other.

Casing 18, which is here of metal, comprises a front bearing configured for rotational mounting of the front end of output shaft 24 and for attaching the starter to a fixed part of the vehicle connected to the mass of the latter, a rear bearing configured for rotational mounting of the rear end of drive shaft 26 and an intermediate cylindrical block sandwiched between the bearings.

The front bearing in FIG. 1 has an opening in its lower part for passage of starter ring gear C which is intended to be driven in rotation by starter 1 when electric motor M is provided with electrical power. The top of the front bearing bears the body 2d of contactor 2 here located above electric motor M provided with an inductor stator 30 surrounding an induced rotor 14 of one piece with drive shaft 26 and comprising at the rear a commutator (not referenced) with electrically conducting segments brushing against at least one pair of brushes (not referenced).

The commutator is here of the frontal type and the brushes are axially orientated in relation to the X axis of shafts 24, 26.

As a variant the commutator may be axially orientated and the brushes may be radially orientated in relation to the X axis as in document FR 2 858 366.

Casing block 18 internally supports stator 30 comprising permanent magnets or as a variant an induction coil, for example of the type described in document EP 0 749 194.

Rotor 14 comprises a body in the form of a package of sheets provided with notches for mounting a coil whose ends are connected to the conducting segments of the commutator. One of the brushes is connected to earth and the other to the positive terminal of the vehicle battery in the manner described below. Advantageously, several pairs of brushes are provided to reduce wear on the brushes.

At its front end drive shaft 26 here has the sun pinion of reduction gear 34 extended by a smooth portion engaging in a blind hole in the rear end of output shaft 24 with a journal bearing in between and an axial wedging ball. The satellite carrier of reduction gear 34 is here firmly crimped to the rear end of output shaft 24, while the ring of reduction gear 34, of rigid plastics material, is of one piece with a metal plate 55, known as the base plate, through overmoulding. Control lever 20, which is advantageously of plastics material to reduce noise, is mounted in an articulated manner at an intermediate point on a support of rigid plastics material overmoulded onto plate 55. This plate 55 acts as a support for body 2d of contactor 2. This body 2d is nested in a circular hole in the upper part of plate 55 between the front bearing and the block of casing 18. Here plate 55, contactor 2 and the block of the front bearing of casing 18 are attached by means of a bolt 56. For more information refer to document FR 2 725 758.

As a variant, reduction gear 34 may be of the type described in FIGS. 2 to 5 of document FR 2 787 833. This reduction gear may be of a different nature and in particular incorporate a torque limiter as in document FR 2 631 094.

Contactor 2 has parts of ferromagnetic material, namely moving core member 2b, a fixed core member 2f and body 2d in which there is provided at least one coil 2a mounted on an annular isolating support 2c. Body 2d is closed off at the rear by a cap 2e of electrically insulating material, here crimped onto body 2d. This cap 2e is also used to secure fixed core body 2f which is axially wedged between a shoulder in cap 2e and body 2d. Cap 2e is provided with axial projections which engage grooves in fixed core member 2f to block cap 2e in rotation and index it angularly. Support 2c engages an annular support (not referenced) for fixed core member 2f. This support 2c and the front end of body 2d are provided centrally with a passage for moving core member 2b. This coil 2a, when electrically activated as a result for example of activating the contact key, creates a magnetic field which causes moving core member 2b to move axially in the direction of fixed core member 2f.

Control rod 3 of moving assembly 3-3a is here electrically insulating and staged in diameter, while moving contact 3a is electrically conducting and may be in the shape of a rectangular plate, of for example copper, movably mounted on rod 3, passing through a central opening in contact 3a in order to do this. As a variant, rod 3 may be electrically conducting, an electrically insulating sleeve being placed between rod 3 and the edge of the central opening of contact 3a. This contact 3a is intended to come into contact with the heads of fixed electrical contact terminals 3e, 3f located in a contact chamber provided in cap 2e. The terminals are of one piece with the base of cap 2e. Terminal 3e is intended to be connected to the positive terminal of the vehicle's battery, whereas terminal 3f is connected by a cable to one of the brushes in the pair of brushes. Axis X1 of rod 3 is the same as the axis of core members 2b, 2f. This axis X1 comprises the axis of contactor 2, which is parallel to the axis X of shafts 24, 26.

The front end of moving core member 2b is connected to the upper extremity of lever 20, which acts through its lower fork-shaped extremity on starter drive unit 1 and forms a moving assembly together with it. Moving core member 2b is blind to house within it a connecting rod 5a to lever 20. This rod 5a passes through the base of core member 2b and is configured to receive an upper articulation axis at its front end for pivotally mounting the upper extremity of lever 20, here comprising an intermediate articulation axis on the support of plastics material overmoulded onto plate 55.

A spring 5, known as a tooth-against-tooth spring, here helical, is mounted in moving core member 2b about rod 5a. This spring 5 is supported on the base of core member 2b and the shouldered head of rod 5. This head is prevented from moving in translation by a washer (not referenced) which, after taking up axial play, is intended to act on the front end of control rod 3 by thrust through a central hole in fixed core member 2f in which the front part of rod 3 is movably mounted.

Rod 3 bears at its rear end contact 3a which is movably mounted on rod 3 opposing the force exerted by two axially acting springs, which are here helical, namely a contact pressure spring 6b and a hold-in spring 6a located on either side of contact 3a. Pressure spring 6b is mounted on an intermediate portion of rod 3 of greater diameter than that of the front and rear ends of rod 3 between a shoulder in the latter housed in fixed core member 2d and the front face of moving contact 3a. This spring 6b presses on rear contact face 3a in the direction of an integral shoulder of rod 3 in the form of a washer held in place by Belleville washer (not referenced) with internal lugs engaging the rear end of rod 3. Hold-in spring 6a bears against the base of cap 2e and the Belleville washer. This spring 6a is mounted at the rear end of rod 3 and is designed to hold moving contact 3a bearing on the rear end of fixed core member 2f when moving contact 3a is not in contact with the heads of terminals 3e, 3f; coil 2a then does not receive any electrical power.

Finally contactor 2 incorporates a return spring 6c, which is here helical, mounted around the front end of moving core 2b and located between the front extremity of cap 2d and a metal stop attached to the front extremity of moving core member 2b to return moving core member 2b and therefore pivoting lever 20 towards their withdrawn resting position (FIG. 1) when no electrical power is provided to coil 2a. In this resting position rod 3 is at a distance from moving core member 2b.

Hold-in spring 6a, which is also known as a cut-off spring, is less stiff than contact pressure spring 6b.

Thus when electrical power is provided, coil or coils 2a create a magnetic field which causes moving core member 2b to move axially rearwards in the direction of fixed core member 2f. After taking up the axial play between the front end of rod 3 and moving core member 2b, moving core 2b moves rod 3 and moving contact 3a, the latter compressing hold-in spring 6a and being brought into contact with the heads of terminals 3e, 3f to make an electrical contact and provide electrical power to electric motor M which then drives output shaft 24 in rotation towards drive shaft 26 and reduction gear 34.

Contact pressure spring 6b then in a final stage allows moving core member 2b to continue its movement to come into contact with fixed core member 2f and rod 3 to move in relation to contact 3a. Finally, contact 3a occupies a withdrawn working position.

Movement of moving core member 2b also causes the upper extremity of control lever 20 to move and pivot about its intermediate articulation axis on the support of one piece with plate 55.

The lower extremity of lever 20 then moves the drive assembly comprising starter drive unit 1 axially forward along output shaft 24 of starter 4 in the direction of a stop 25 which is of one piece with the front end of output shaft 24 rotatably mounted in the front bearing, here via a journal bearing. When the starter drive unit and the control lever are of plastics material metal cladding means may be permanently fixed to the control lever in those parts where there is friction with the starter drive unit as described in document FR 2 862 721, to which reference will be made later.

When electrical power is disconnected from coil 2a, moving core member 2b is no longer drawn rearwards, pressure spring 6b relaxes and hold-in spring 6a pushes control rod 3 back towards the front until moving contact 3a abuts against fixed core member 2f. Return spring 6c also acts to return moving core member 2b and lever 20 towards their withdrawn resting position which can be seen in FIG. 1.

Contact 3a is therefore movably mounted on rod 3 between an advanced resting position and a withdrawn working position. Likewise lever 20 is mounted in an articulated manner on rod 5a and on the support of one piece with plate 55 to move starter drive unit 1 axially between a withdrawn resting position and an advanced working position bounded by stop 25.

Contactor 2 therefore has two functions, namely that of moving assembly 3-3a and moving lever arm 20/starter drive unit 1 assembly in the opposite direction.

As will better be seen in FIG. 2, which is a view of the front part in FIG. 1 with the rear part of starter drive unit 1 cut off, starter drive unit 1 comprises at the front a pinion 11 and at the rear a drive element 118 fitted with a drive bush through which output shaft 24 of the starter passes and a groove receiving the lower fork-shaped extremity of lever 20. In this FIG. 2 reference numbers 20a and 20b indicate the upper articulation axis and the intermediate articulation axis of lever 20 respectively. Axis 20b is received with axial play in an oblong supporting hole 36 of plastics material of one piece with plate 55 through overmoulding. Reference 116 indicates a bearing, here a needle roller bearing, located radially between the outer periphery of the front end of shaft 24 and the inner periphery of a hollow cylindrical projection on the front bearing of bearing 18. Bearing 116 allows shaft 24, which has a smooth portion 22 at the front bounded by stop 25, and a larger diameter portion 110 at the rear, to rotate. This portion 110 is provided on its outer periphery with helical grooves 28 to act together with matching helical grooves 29 forming part of the inner periphery of the rear end of the drive bush of drive element 118. Grooves 29 surround grooves 28. Thus a system of the internally and externally threaded nut/screw type is formed; the teeth of grooves 29 penetrate the matching grooves in grooves 28 and vice versa. Starter drive unit 1 is thus driven in a rotational and translational movement along output shaft 24 when it is moved by the lower extremity of lever 20.

Drive element 118 is axially connected to pinion 11 by an idling roller bearing 126 which is subjected to the force of the springs. The idling bearing enables the drive bush of drive element 118 to drive pinion 11 and ring gear C in a direction of rotation corresponding to that of shaft 26 of motor M when the heat engine starts. As soon as the rotation speed of the heat engine exceeds a threshold the idling bearing disengages the rotating drive of pinion 11 from shaft 26 to safeguard the components of the starter, in particular the latter's electric motor.

The teeth of pinion 11 belong to a sleeve 111 which is extended rearwards through excess thickness to form the outer cylindrical track of idling roller bearing 126. This sleeve 111 is axially guided on smooth portion 22 through the intermediary of a bush 124 located radially between the outer periphery of portion 22 and the inner periphery of the sleeve which is of one piece with bush 124. The bush of starter element 118 is extended forwards by a flange which is transversely orientated in relation to the axis X of shaft 24. This flange is extended on its outer periphery by an axially orientated cylindrical skirt extending forward. This skirt is internally configured to form housings for rollers 126 and their associated springs. These housings bound the outer track of rollers 126 and are enclosed by a washer 130. Rollers 126 are axially imprisoned between the flange of drive unit 118 and washer 130 bearing axially on the free end of the drive element's skirt. This washer 130 is held in place by the base of a cap 131, which is here of metal. This cap 131, in the form of a cup, envelopes the skirt of drive element 118 and is axially immobilised by the material of its free extremity being bent back onto the outer chamfered periphery of the flange of drive element 118.

The groove housing the lower fork-shaped extremity of lever 20 is bounded by the flange of drive element 118 and a washer which is of one piece with the rear extremity of the bush of drive unit 118. Pinion 11 of starter drive unit 1 is at a distance from toothed ring C in the withdrawn resting position. When moving core member 2b is in movement, the lower end of lever 20 axially moves pinion 11 along shaft 24 in the direction of stop 25.

Two situations may arise. In the first situation pinion 11 meshes with ring gear C before electric motor M starts, the teeth of pinion 11 penetrate the groove-shaped hollows separating the teeth of ring gear C. Axial movement of the drive element then continues until pinion 11 abuts stop 25.

In the second situation the teeth of pinion 11 abut against the teeth of ring gear C. In this case tooth-against-tooth spring 5 is compressed and the pinion turns, in particular when the electric motor is started, to mesh with ring gear C. Of course as a variant tooth-against-tooth spring 5 may be located at the inner extremity of the control lever as described in document GB 225 757, to which reference will be made later, FIGS. 1 to 3 of the latter showing the positions of the pinion with respect to the toothed starter ring gear. In this document GB 225 757, the idling bearing comprises friction discs which are pressurised by a cup and a locking ring. In a variant the friction clutch is of the frustoconical type as in document WO 2006/100353 in accordance with the precharacterising clause of claim 1.

Of course in order to prevent the starting ring gear from being milled by the pinion when the teeth of the pinion abut against the teeth of the starting ring gear means may be provided as described in document WO 03/006824, to which reference will be made later, to cause the electric motor to rotate at slow speed initially, referred to as pre-rotation and then full power, the drive element being immobilised in rotation by cooperating means between the fork and the drive element so that it passes from its resting position to the position in which it meshes with the starter drive gear. These means of immobilisation during rotation may be of the interlocking or friction type.

As explained in document FR 2 631 094, when a heat engine starts it may give rise to malfunctions such as kick-backs, reverse rotation of this engine being transmitted to output shaft 24 and drive shaft 26. The same applies when the heat engine stops, its crankshaft and therefore ring gear C may turn in a reverse direction during the final descent of one or more pistons of the heat engine.

More specifically, it has been found that the pistons of the heat engine stop in the same position as oscillating phenomena come to an end.

If the starter is started before starting ring gear C has come to a complete stop, rotation of ring gear C may mill pinion 11 when the latter is in the tooth-against-tooth position with ring gear C because of the fact that the starter, because of its configuration, and the transmission from the starter to the electric motor oppose this rotation.

This is in particular due to the fact that the rotor of the electric motor is already driven in the direction of rotation for starting the heat engine. It also arises from the friction force between the brushes and the commutator, the inertia of the rotor and possibly the presence of the reduction gear.

When the pinion of the starter drive unit engages ring gear C and the resistant torque of the crankshaft is greater than that of the electric motor, the commutator of that electric motor turns, giving rise to premature wear or even destruction of the brushes.

Vibration is produced. More specifically, when the heat engine is started, the starter must start the heat engine from the resting condition up to a minimum velocity, generally close to 100 rpm, to allow the initial explosions to take place. Then the starter must accompany the heat engine as it runs until the latter reaches its independent running speed which is generally located towards 300 to 400 rpm in the case of a 4 cylinder engine, the idling speed of a heat engine being generally located at around 750 rpm.

Thus when the heat engine is started up or stopped starter 4 must overcome the resistant compression forces in the cylinders in addition to the internal friction forces in the heat engine. Furthermore, at the start of the decompression phase in these cylinders the angular acceleration of the starter is less than that of the heat engine and the idling bearing acts to bring about disengagement. At the end of the decompression stage the heat engine slows down while the starter continues to accelerate until the idling bearing engages again; the starter again transmitting energy to the heat engine.

Graph A (number of heat engine rpm as a function of time) in FIG. 15 illustrates the aforesaid phenomena; the vibration spectrum is different when the heat engine comes to a stop.

Noise results, in particular because of the fact that pinion 11 and ring gear C are of metal, and from the impacts due in particular to take-up of the meshing play with starter ring gear C when passing from the stages of the idling bearing being disengaged to the idling bearing being engaged and vice versa.

All of this is accentuated when the starter must perform the Stop & Start function, which can be used to stop the heat engine because of traffic conditions, such as when stopping at a red light or in a traffic jam, and then start the heat engine again to reduce fuel consumption. More frequent starts thus result.

In order to do this use is most frequently made of an electronically controlled starter circuit and as explained in document EP 1 462 645 a microcontroller performing control functions, in particular non-starting of the starter when the heat engine is rotating, is inserted.

In general, even with a friction disc starter of the type described in document GB 225 757, it follows from what has been stated above that impacts and noise which are still significant are produced.

### Object of the Invention

This invention has the object of reducing impacts and noise within the context of a friction disc starter drive unit.

According to the invention, the moving starter drive unit/control lever assembly which can move between a withdrawn resting position and an advanced position to mesh with the toothed starter gear of a heat engine of the type comprising:
a starter drive unit equipped with a pinion for engaging with the toothed starter ring gear in an advanced position and having an axis of axial symmetry;
a drive element forming part of the starter drive unit;
a friction clutch between the drive unit and the pinion, this clutch being provided with a reaction plate, a pressure element integral with the drive and at least one friction element which can be tightened between the reaction plate and the pressure element;
in which the pressure element is at least partly located within a casing which is both integral in rotation with the pinion and also comprises a plate comprising the reaction plate of the friction clutch;
a pivoting control lever comprising an upper extremity capable of being moved by control means forming part of a starter and a lower fork-shaped extremity comprising two arms for acting on the starter drive unit;
   is characterised in that
the control lever is associated with means for engaging the friction clutch,
there are articulation means between the control lever and the means engaging the friction clutch,
and the lever is configured to allow the casing to move initially axially along the axial axis of symmetry towards the advanced position engaging with the starter ring gear, while the means for engaging the clutch are configured for subsequently axially displacing the drive unit in the direction of the reaction plate to engage the friction clutch.

Thanks to the invention, in a first stage the lever moves the casing in the direction of the starter ring gear.

The engaging means act in a second stage which is delayed in relation to the control lever. These engaging means are separate from the lever, being mounted on the articulation through the articulation means.

Thus in a first stage the pinion can move freely in both directions (clockwise and anticlockwise) to mesh with the starter gear ring while it is still turning.

In a second stage the clutch is engaged to transmit the torque.

The engaging means of the clutch thus act in a delayed way.

Impacts and noise are reduced when the pinion penetrates the starter gear ring to mesh with it.

There is no need to wait for the heat engine to come to a complete stop in order to be able to restart it. The pinion may penetrate within the ring gear even if the latter is rotating in a reverse direction.

A mechanical synchroniser is thus constructed, the rotation speed of the pinion adjusting to that of the starter ring gear.

The time between two restarts of the heat engine can thus be shortened.

In accordance with the invention, a starter for an internal combustion heat engine, in particular a motor vehicle, is characterised in that it comprises such a moving assembly.

According to other features taken in isolation and/or in combination:
each arm of the lever bears a projecting shoe externally configured to form a cam which is capable of coming into contact with the casing to move the latter axially towards the advanced position in which it meshes with the starter ring gear;
the casing bears shoes externally configured in the shape of a cam each of which can come into contact with an associated arm of the lower extremity of the lever to axially move the casing towards the advanced position in which it meshes with the starter toothed ring;
the engaging means of the friction clutch are connected to the lever and are configured to act on the drive unit with delay and press the latter in the direction of the reaction plate to engage the clutch;
the engaging means for the friction clutch incorporate a friction clutch engaging member which is attached to the articulation at the lower extremity of the lever and which is configured to act on the drive unit with delay and press this in the direction of the reaction plate to engage the clutch;
the moving assembly comprises a double lever;
the means for engaging the friction clutch include an additional pivoting lever which is configured to allow the control lever to be mounted with articulation between the upper and lower extremities thereof;
the additional lever comprises an upper extremity which can be moved by control lever manoeuvring means after play has been taken up;
the additional lever has a mounting strut to the articulation of the control lever between its upper and lower extremities;
the control lever is mounted in the additional lever through imbrication;
the means for engaging the friction clutch incorporate a friction clutch engaging member which is connected to the articulation to the lower extremity of the additional lever and which is configured to act on the drive unit with delay and press the latter in the direction of the reaction plate to engage the clutch;
the casing comprises an engaging ring and a skirt connecting the reaction plate to the engaging ring, each projecting shoe in the form of a cam being configured to come into contact with the casing engaging ring;
the casing comprises a connecting skirt extending axially to the outer periphery of the reaction plate, being directed in a direction opposite to the pinion, each projecting shoe in the form of a cam being configured to come into contact with the connecting skirt of the casing;
the casing comprises a connecting skirt extending axially to the outer periphery of the reaction plate when driven in a direction opposite to the pinion and is also provided with projecting shoes in the shape of a cam; each cam-shaped projecting shoe being configured to come into contact with the appropriate arm of the control lever;
the casing comprises an engaging ring provided with projecting shoes in the form of a cam and a skirt connecting the reaction plate to the engaging ring, each cam-shaped projecting shoe being configured to come into contact with a corresponding arm of the control lever;
the casing comprises a connecting skirt extending axially to the outer periphery of the reaction plate when directed in a direction opposite to the pinion, each cam-shaped projecting shoe being configured to come into contact with the connecting skirt of the casing;
each cam-shaped projecting shoe comprises a summit portion which is flat overall and able to come into contact with the engaging ring or with the connecting skirt of the casing or with one of the associated arms of the control lever;
the lower extremity of each lever arm has a rounded part, each summit portion of a shoe being extended at its inner periphery by an inclined disengaging portion extending in the direction of a flat portion which is connected to the rounded part;
the shoes are intended to come into contact via their summit portion, that is to say bear against, the engaging ring or the connecting skirt of the casing in two diametrically opposite parts of the latter;
the clutch engaging member is mounted with articulation on the lower fork-shaped extremity of the control lever between the arms of that lower extremity;
the clutch engaging member is mounted with articulation on the lower fork-shaped extremity of the additional lever between the arms of that lower extremity;
the engaging member comprises a bow mounted with articulation on the lower fork-shaped extremity of the additional lever between the arms of that lower extremity;
the bow has at each of its ends an axis each of which is rotatably mounted in a hole in an associated arm which comprises the lower part of the additional lever;
the bow is of semi-circular shape;
the clutch engaging member is mounted in a groove of one piece with the drive;
the engaging member comprises an engaging yoke mounted in a groove of one piece with the drive;
the engaging yoke is open at its inner periphery so that it can be mounted in the groove of one piece with the drive;
the engaging yoke is engaged by being mounted in the groove of one piece with the drive by a mounting of the bayonet type;
the opening in the engaging yoke is of oblong shape to permit radial movement of the engaging yoke in relation to the groove;
the yoke comprises two branches connected together by means of at least one external portion;
the external portion is of rounded shape;
the edges of the branches are parallel;
the branches are separated from each other by a distance which corresponds overall to the outside diameter of the base of the groove;
the yoke bears against one of the sides of the annular groove in two diametrically opposing parts;
each branch is mounted with articulation on the lower extremity of an associated arm of the lever;
one of the associated arm/branch elements bears a pivot penetrating a hole forming part of the other of the associated arm/branch elements;
each branch laterally bears a pivot capable of penetrating in a matching way a cylindrical hole in each lever arm at its lower extremity;
each lever arm comprises a pivot penetrating a hole each forming part of one arm of the yoke in a matching way;
there is small radial play between the pivot and its associated hole;
one of the sides of the annular groove is thicker;
the branches of the engaging part are mounted with axial play in the groove;
the base of the groove is shaped by means of a member applied to the drive;
in the resting position the clutch is disengaged with the appearance of axial play;
the thicker side of the groove receiving the engaging member of the clutch has a thickness which is greater than that of the axial play;
an axial resiliently acting washer is placed between the reaction plate and the drive to push the drive back towards the resting position;
the resilient washer is mounted in an annular groove located in the inner periphery of the reaction plate;
the groove is open in the direction of the drive;
the groove is shaped by means of a reduction in thickness presented by the reaction plate on its inner periphery;
the resilient washer comprises a corrugated washer;
the friction clutch is a friction clutch of the frustoconical type comprising at least one friction member in the form of a friction lining anchored in a housing in the front part of the drive comprising the pressure element;
on its outer periphery this lining has a convex frustoconical friction surface acting together in a matching way with a concave frustoconical friction surface located in the outer periphery of the reaction plate which is of one piece with the pinion, at least in rotation;
the friction clutch comprises at least one friction element in the shape of a friction disc located between a pressure element in the form of a pressure plate of one piece with the drive and the reaction plate;
the pressure plate comprises an integral flange of the drive;
the casing retaining ring is hollowed at its inner periphery to form a shoulder capable of acting together with the rear surface of the flange;
the friction clutch incorporates two friction discs which are of one piece in rotation with a front portion of the drive having axial mobility;
the clutch comprises three friction discs of one piece with the reaction plate in rotation;
the three friction discs are of one piece in rotation with the reaction plate with axial mobility via the skirt of the casing;
each disc which is of one piece in rotation with the front portion of the drive is placed between two friction discs which are of one piece in rotation with the skirt so that there is an alternation of friction discs;
the inside diameter of the casing retaining ring is greater than the outside diameter of the thicker side of the groove receiving the engaging member of the clutch;
the inside diameter of the skirt of the casing is larger than the outside diameter of the thicker side of the groove receiving the engaging member of the clutch;
the thicker side partly penetrates the casing;
the pinion of the drive element is of one piece with a sleeve of the reaction plate;
the pinion is of one piece in rotation, with axial mobility, with a sleeve of one piece with the reaction plate;
a resilient member is placed between the reaction plate and the pinion mounted with axial mobility on a sleeve which is of one piece with the reaction plate.

Other features and advantages of the invention will be apparent from a reading of the following non-restrictive description, for an understanding of which reference will be made to the appended drawings.

### BRIEF DESCRIPTION OF THE DRAWINGS

FIG. 1 is a view in axial cross-section of a starter for a heat engine of a motor vehicle according to the prior art which is illustrated in the resting position;

FIG. 2 is a view of the front part of FIG. 1 with the rear part of the starter drive unit cut off;

FIG. 3 is a view in axial cross-section of the moving starter drive unit/control lever assembly with an engaging yoke forming part of the friction clutch engaging means according to a first embodiment of the invention for the withdrawn resting position of this moving assembly—the starter drive unit pinion being then at a distance from the toothed starting ring gear;

FIG. 4 is a view in axial cross-section of the starter drive unit in FIG. 3 mounted on the output shaft of the starter, with play present within the friction clutch;

FIG. 5 is a perspective view of the drive element in FIGS. 3 and 4;

FIG. 6 is a perspective view of the control lever in FIG. 3 fitted with cams to act on a casing which in rotation is of one piece with the pinion of the starter drive unit;

FIG. 7 is a front view of the control lever equipped with its friction clutch engaging member;

FIG. 8 is a view similar to that in FIG. 3, without the output shaft from the starter, at the start when the pinion of the starter drive unit engages the toothed starter ring gear;

FIG. 9 is a view similar to that in FIG. 8 for a position in which the pinion partly penetrates within the starting ring gear with contact between the engaging member of the friction clutch and the starter drive unit drive;

FIG. 10 is a partial view similar to that in FIG. 4 in which the friction clutch is engaged;

FIG. 11 is a view similar to those in FIGS. 8 and 9 for an advanced position of the moving assembly in which the pinion fully penetrates the starter drive gear; the friction clutch being engaged;

FIG. 12 is a view in partial cross-section of the starter drive unit in a second embodiment of the invention;

FIG. 13 is a view similar to that in FIG. 8, the pinion in FIG. 12 being in a tooth-against-tooth position in relation to the starter ring gear;

FIG. 14 is a view in partial cross-section of the front of the starter drive unit equipped with needle roller bearings for movement along the starter output shaft;

FIG. 15 is a view of the windows in which the moving assembly according to the invention can act with the rotation speed N (number of rotations per minute) of the heat engine being shown as the ordinate and time as the abscissa;

FIG. 16 is a perspective view of a double-lever assembly intended to act on the starter drive unit in FIG. 4 in a third embodiment of the invention;

FIG. 17 is an exploded view of the double lever in FIG. 16.

### DESCRIPTION OF EMBODIMENTS OF THE INVENTION

In the figures identical, similar or analogous elements are indicated by the same reference numbers.

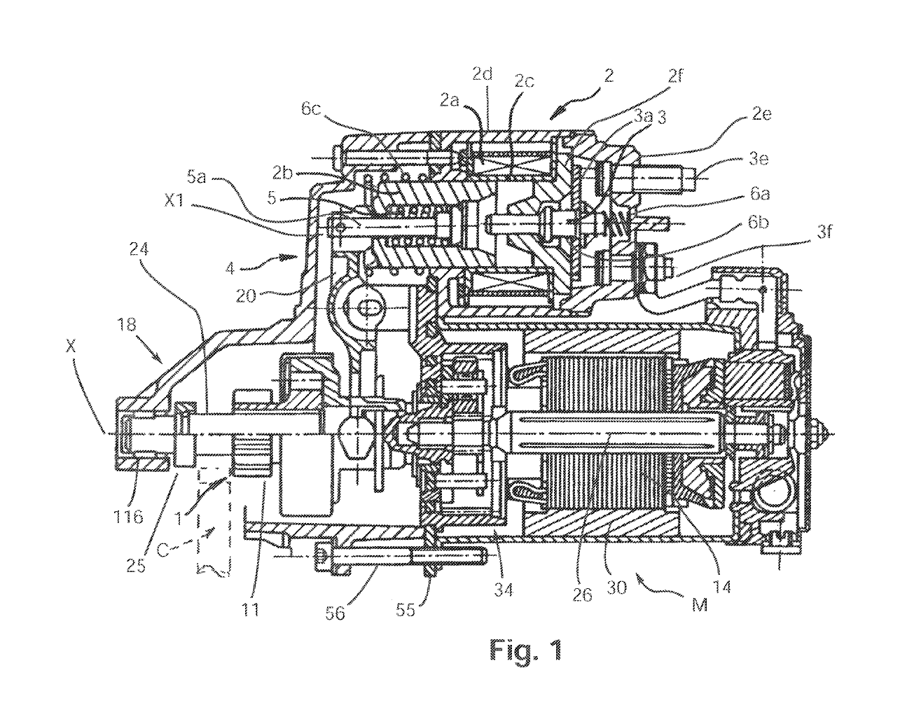

Front to rear orientation corresponds to left-to-right orientation in FIGS. 1, 3 and 4.

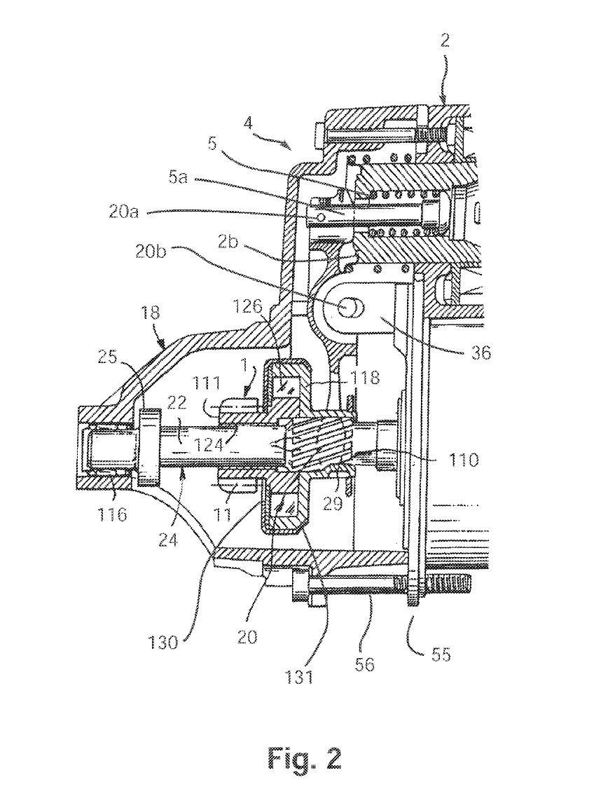

Starter drive unit 1 according to the invention is mounted in the location of and instead of starter drive unit 1 in FIGS. 1 and 2. It comprises an axis of symmetry which is the same as the axis of symmetry X of the output shaft 24 of the starter.

In the figures the axial, radial and transverse orientations are defined in relation to this axis X of shaft 24 and starter drive unit 1.

This starter drive unit 1 comprises a pinion 11 which is capable of meshing with a starter toothed ring gear C of the thermal engine, a drive element 118 and a friction clutch 300 between drive element 118 and a friction clutch 300 located between drive element 118 and pinion 11. This clutch 300 is configured to comprise an idling mechanical link between pinion 11 and drive element 118. In order to achieve this it comprises a pressure element, a reaction plate 112 and at least one friction element 301 located between plate 112 and the pressure element. It is able to come into frictional contact either directly or indirectly with reaction plate 112 under the tightening force exerted by the pressure element in order to transmit the torque from shaft 24 to gear ring C via pinion 11.

The teeth of pinion 11 and gear ring C may be orientated axially with respect to the X axis.

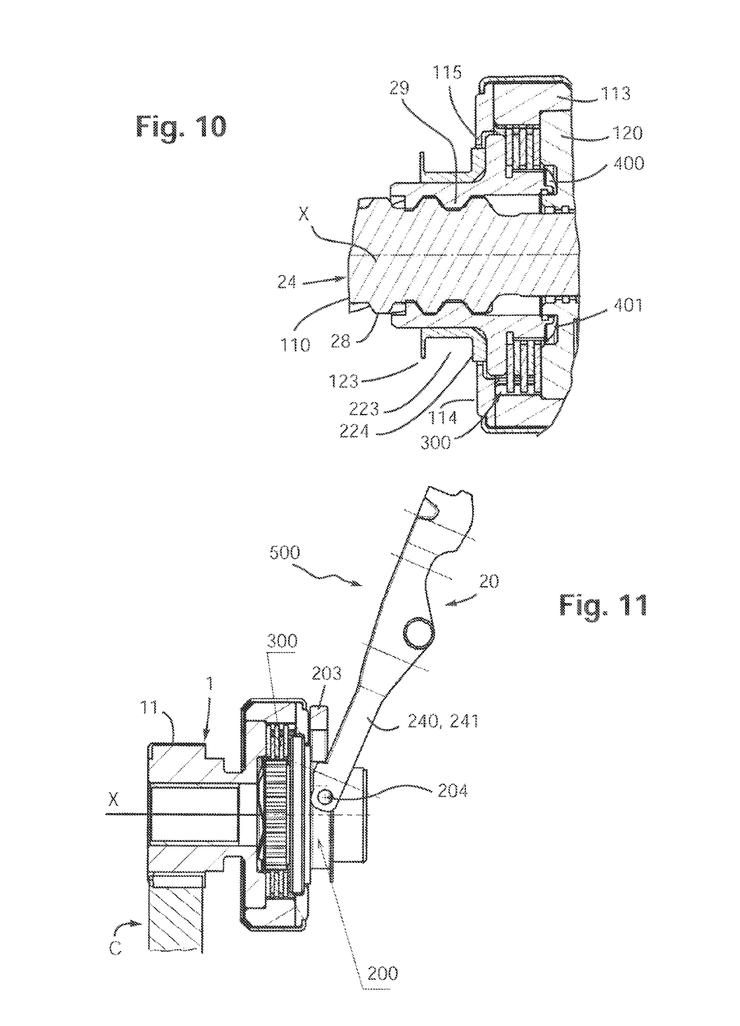

Thus in the advanced position in which pinion 11 is in the meshing position with gear ring C (FIGS. 10 and 11), clutch 30 is engaged. Torque is then transmitted from shaft 24 to gear ring C. Pinion 11 is then linked in rotation with drive element 118.

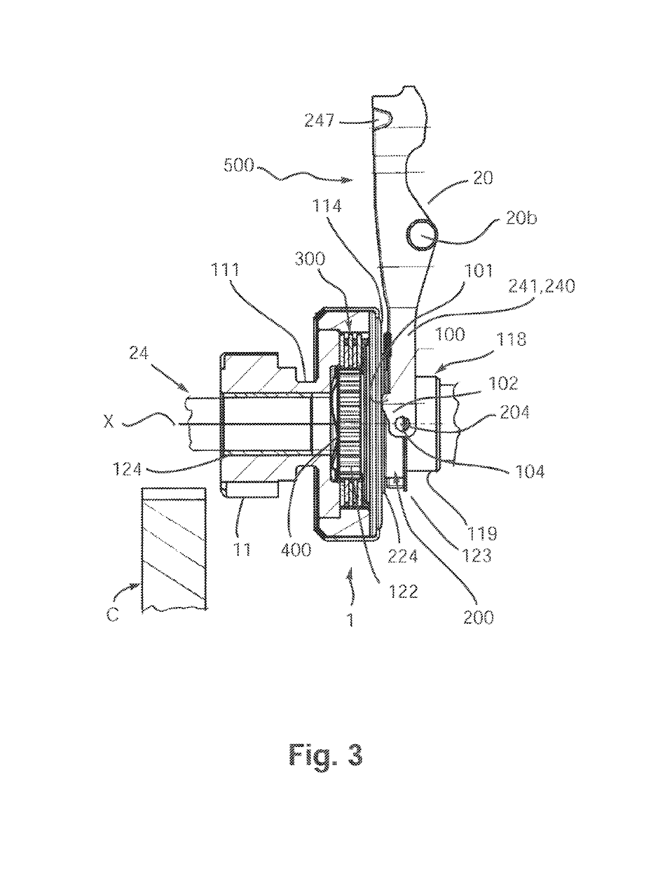

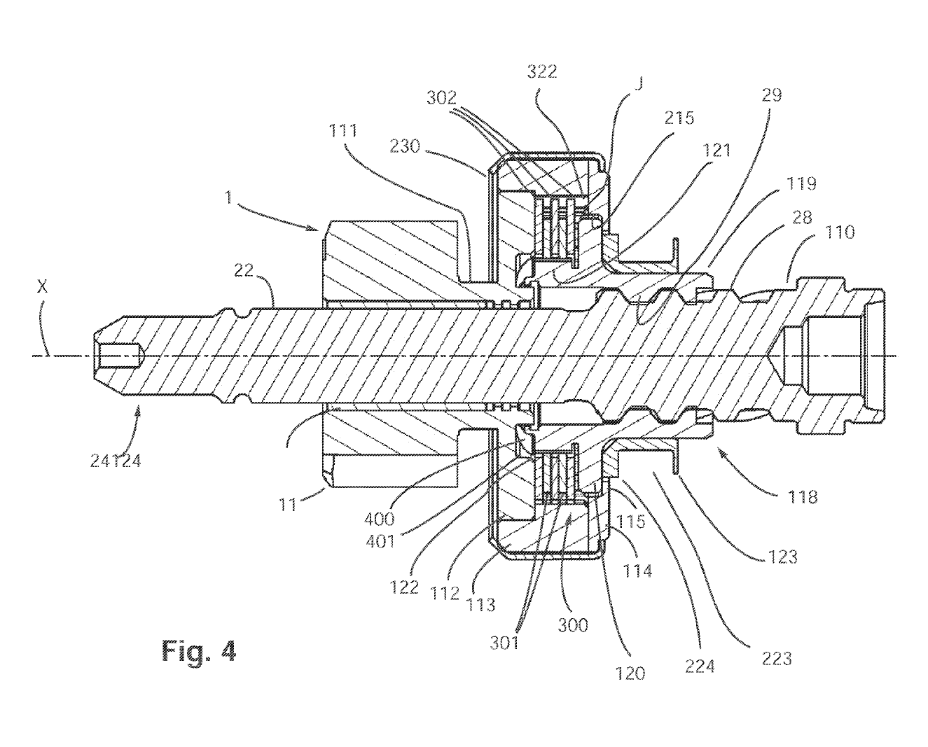

In the withdrawn resting position of starter drive unit 1 (see FIGS. 3 and 4), clutch 300 is, according to one characteristic, disengaged in such a way that pinion 11 can turn freely.

Clutch 300 may be a friction clutch of the frustoconical type as described in document WO 2006/100353 to which reference will be made later. It therefore comprises (see FIGS. 2 to 5 of that document WO 2006/100353) at least one friction element in the form of a friction lining anchored in a housing in the front part of drive element 118 comprising the pressure element. This lining has on its outer periphery a convex frustoconical friction surface acting in a matching way together with a concave frustoconical friction surface provided in the outer periphery of a reaction plate which is of one piece with the pinion, at least in rotation.

This reaction plate has on its outer periphery an extension for the attachment of a cap comprising at its rear end a ring through which the starter drive unit passes centrally. This cap has an annular skirt attached to the extension of the reaction plate. The friction lining is thus housed within a casing comprising the reaction plate, the ring and the skirt connecting the reaction plate to the ring comprising the engaging ring of the casing through which drive element 118 comprising the pressure element partly implanted in the casing passes.

As a variant, as illustrated in FIGS. 3 to 13, friction clutch 300 may comprise at least one friction element in the form of a friction disc 301 located between a pressure element in the form of a pressure plate 120 of one piece with drive element 118 and a reaction plate 112.

In the manner described below, disc 301 is also housed in a casing 112, 113, 114 comprising an engaging ring 114 through which drive element 118 passes centrally. It has a transverse orientation. These front and rear surfaces are parallel to each other in FIGS. 3 to 13.

The pressure plate is implanted in the casing.

The invention is generally partly based on the presence of the casing within which the pressure element is at least partly located. Advantageously pressure element 118, 120 can move axially in relation to reaction plate 112 within the limits of axial play. Preferably this axial play is ensured by means of a resilient spring 400 which acts axially bearing on reaction plate 112 to act on drive element 118 and push the latter rearwards.

The invention is partly based on engaging ring 114 of the casing.

As a variant the invention may be partly based on skirt 113 of the casing.

Friction disc 301 may be connected in rotation to drive element 118 by a matching shape connection permitting disc 301 to move axially in relation to drive element 118.

In another embodiment disc 301 may be of one piece with pressure plate 120 and come into contact with reaction plate 112 either directly or indirectly.

In yet another embodiment, disc 301 may be of one piece with the reaction plate and come into contact with pressure plate 120 directly or indirectly.

When starter drive unit 1 is in the withdrawn resting position (see FIGS. 3 and 4), there is preferably axial play between friction disc 301 and pressure plate 120. In the case of an aforesaid friction clutch of the frustoconical type there is preferably axial play between the reaction plate and the friction lining. This play permits pinion 11 to rotate in relation to drive element 118, and for pressure element 118, 120 to move axially in relation to reaction plate 112.

This play may advantageously be ensured through a resilient washer 400, acting axially, located between reaction plate 112 and drive element 118. This washer 400 bears on the rear surface of reaction plate 112 and acts on the front surface of drive element 118 to push the latter rearwards and therefore towards the withdrawn resting position. This arrangement favours better rotation of pinion 11 in relation to the drive element, and better detachment of disc 301 from pressure plate 120 or of the friction lining from reaction plate 112.

This washer 400 increases the rate of detachment of drive element 118 provided with helical grooves 29 engaging matching helical grooves 28 in shaft 24. This washer 400 thus favours the unscrewing of drive element 118 and therefore reduces detachment time.

This arrangement also reduces noise, because it prevents contact between drive element 118 and reaction plate 112 when clutch 300 is not engaged.

In the advanced position in which pinion 11 engages with ring gear C (FIGS. 10 and 11), disc 301 is held tight against plates 112, 120. Torque is then transmitted from shaft 24 to ring gear C. Pinion 11 is then linked in rotation with drive element 118.

Pressure plate 120 is of one piece with drive element 118, whereas reaction plate 112 (FIGS. 4 and 10) is of one piece in rotation with pinion 11 and belongs to casing 112, 113, 114. Plates 120 and 112 are transversely orientated and parallel to each other.

As in FIGS. 1 and 2 and as may be seen for example in FIGS. 3 and 4, pinion 11 may be supported on a sleeve 111 which is axially orientated. This sleeve 111 is extended at its rear end by reaction plate 112. This plate 112 is itself extended at its outer periphery by an annular skirt 113 which is axially orientated. This skirt 113 is directed rearwards in the direction of drive element 118.

Skirt 113 thus extends axially to the outer periphery of reaction plate 112 by being directed in a direction opposite to pinion 11.

The presence of sleeve 111 is not essential, pinion 11 may be of one piece with the reaction plate as in the figures in aforesaid document WO 2006/100353.

The length of sleeve 111 will depend on applications.

Reaction plate 112 may be of one piece with sleeve 111. As a variant, reaction plate 112 is separate from sleeve 111, being assembled to the latter by for example bolting, riveting, using fixing members, such as screws, or welding. As a variant, sleeve 111 is extended rearwards by a wall which is transversely orientated. This wall may be perforated for assembly with reaction plate 112, for example of cast iron, overmoulded onto the wall. In these variants, the material of plate 112 may be selected so that it has an adequate friction coefficient.

Skirt 113 may be of one piece with reaction plate 112.

As a variant, skirt 113 may be separate from reaction plate 112, being assembled to the latter by for example bolting, riveting, using fixing attachments such as screws, or welding. In a variant the wall extending sleeve 111 in the manner described above is itself extended by an axially orientated sleeve which is perforated so that the skirt can be assembled with this axially orientated sleeve by overmoulding. In these two cases the material of skirt 113 may be selected so that it has the required qualities for the function which it has to perform.

As a variant, in the manner described below, skirt 113 is assembled to the reaction plate by means of a cap 230. This skirt may belong to the cap as in document WO 2006/100353.

Pinion 11 may be of one piece with sleeve 111, as in FIGS. 3, 4 and 8 to 11.

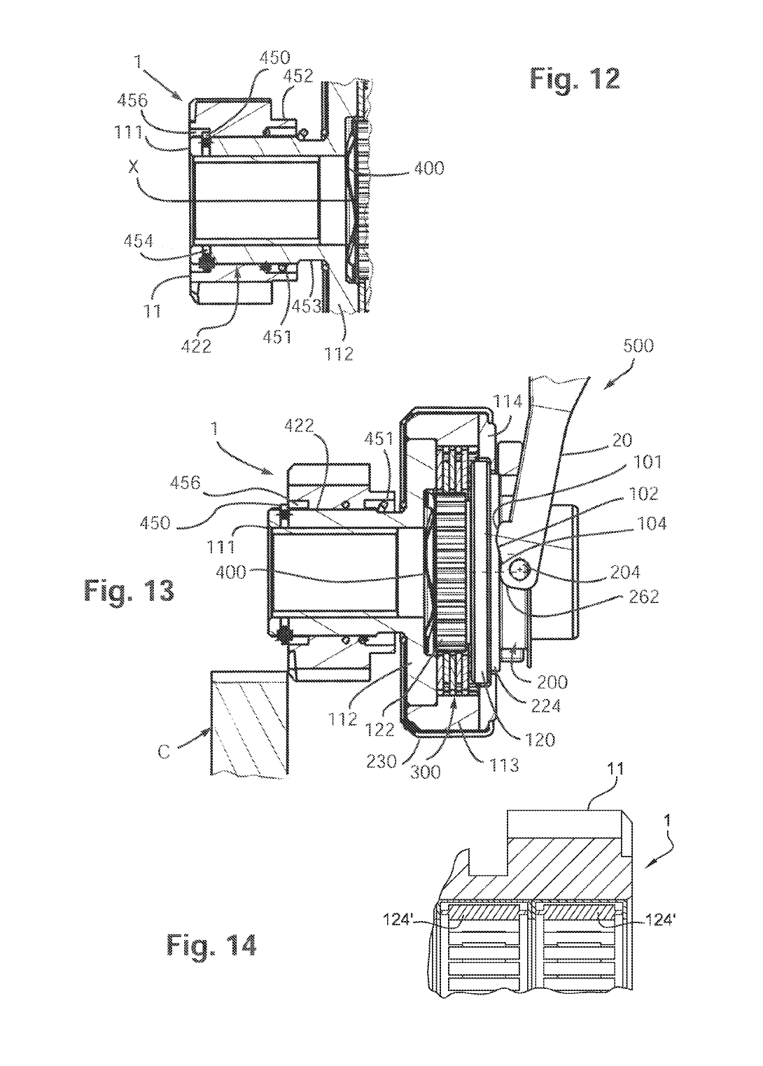

As a variant, pinion 11 may be separate from sleeve 111, being integral in rotation with the latter with the possibility of axial movement, as may be seen in FIGS. 12 and 13.

As a variant, pinion 11 is fixedly attached by crimping or welding to sleeve 111.

It follows from the above that the material of pinion 11, such as mechanically strong steel, and the material of reaction plate 112 and skirt 113 may be selected in an optimum way according to the function which they have to perform.

The grade of the material of pinion 11 may be appropriate for the needs of meshing with gear ring C (mechanical strength, wear resistance, low noise emission, etc.), while the grade of the material of reaction plate 112 may be especially appropriate for the needs of engagement and the transfer of torque (wear resistance, the value of the friction coefficient, mechanical strength, etc.).

Pinion 11 and reaction plate 112 may be obtained be machining or heat treatment, being for example of metal.

As a variant, pinion 11 and reaction plate 112 are obtained by moulding, in particular by sintering. Sintering may comprise sintering of two materials when reaction plate 112 is of one piece with pinion 11. This also applies to skirt 113, which may be obtained by moulding with reaction plate 112.

As a variant, plate 112 may be provided with a layer whose friction coefficient is compatible with that of friction disc 301. As a result of this arrangement the material of plate 112 may be the same as that of metal pinion 11. This layer is for example adhesive bonded to the rear surface of reaction plate 112.

As a variant, in a manner described below, the layer is replaced by a friction disc 302 connected in rotation with skirt 113 which is of one piece with reaction plate 112 through a matching shape connection which permits disc 302 to move axially with respect to reaction plate 112. As a variant, friction disc 302 may be attached to the reaction plate by adhesive bonding or otherwise.

All the above characteristics apply to pressure plate 120 of the clutch, which may be fixedly attached to drive bush 119 borne by drive element 118, or in a variant be overmoulded on a transverse wall which is of one piece with bush 119, or be of one piece with that bush 119. In all cases pressure plate 120 belongs to drive element 118. This plate 120 is of one piece with drive element 118, being fixedly attached through bush 119.

Plates 112 and 120 may therefore be of cast iron in one embodiment. Plate 120 may therefore in a variant be provided with a layer whose friction coefficient is compatible with that of friction disc 301.

Starter drive unit 1 belongs to a moving assembly 500 comprising control lever 20, as in FIGS. 1 and 2. This assembly 500 can move between a withdrawn resting position (FIG. 3), in which pinion 11 is at a distance from starter toothed ring C, and an advanced position (FIG. 11) in which it meshes with that starter ring gear C; the pinion then abuts stop 25 in FIG. 2.

According to the invention this assembly 500 is configured in the manner described below to form a synchroniser which enables pinion 11 to mesh with ring gear C before the latter has ceased rotating. The heat engine can therefore be restarted more quickly before the rotation of ring gear C has come to a complete halt, with minimum noise and reduced impacts between the teeth of pinion 11 and ring gear C. The time between two successive restarts of the heat engine may therefore be reduced.

Lever 20 is fitted in the location of and in place of that in FIGS. 1 and 2 in such a way that the upper extremity of lever 20 can be moved by electromagnetic contactor 2 in FIGS. 1 and 2.

According to one characteristic this moving assembly 500 comprises engaging means 200-200A, 120A for friction clutch 300. These engaging means 200-200A, 120A are associated with control lever 20 and are configured to act with delay on drive element 118 and press the latter in the direction of reaction plate 112 to engage friction clutch 300. This is brought about when the moving assembly moves from the resting position to the advanced position in which it meshes with the starter ring gear, in other words during the stage of engaging and driving ring gear C.

These engaging means 200-200A, 120A are connected to lever 20. According to one feature, there are articulation means between lever 20 and these engaging means 200-200A, 120A.

According to one characteristic, lever 20 is configured so that initially casing 112, 113, 114 can be moved axially along the axial axis of symmetry X towards the advanced position of meshing with starter ring gear C, while the means for engaging the friction clutch are configured for axial displacement of drive element 118 in the direction of reaction plate 112 in a second stage to engaging friction clutch 300.

According to one characteristic, the engaging means for friction clutch 300 may comprise an engaging member 200, 200A for friction clutch 300.

This member 200 may be attached to the lower extremity 240, 241, 242 of lever 20 as is more particularly apparent in FIGS. 6 and 7.

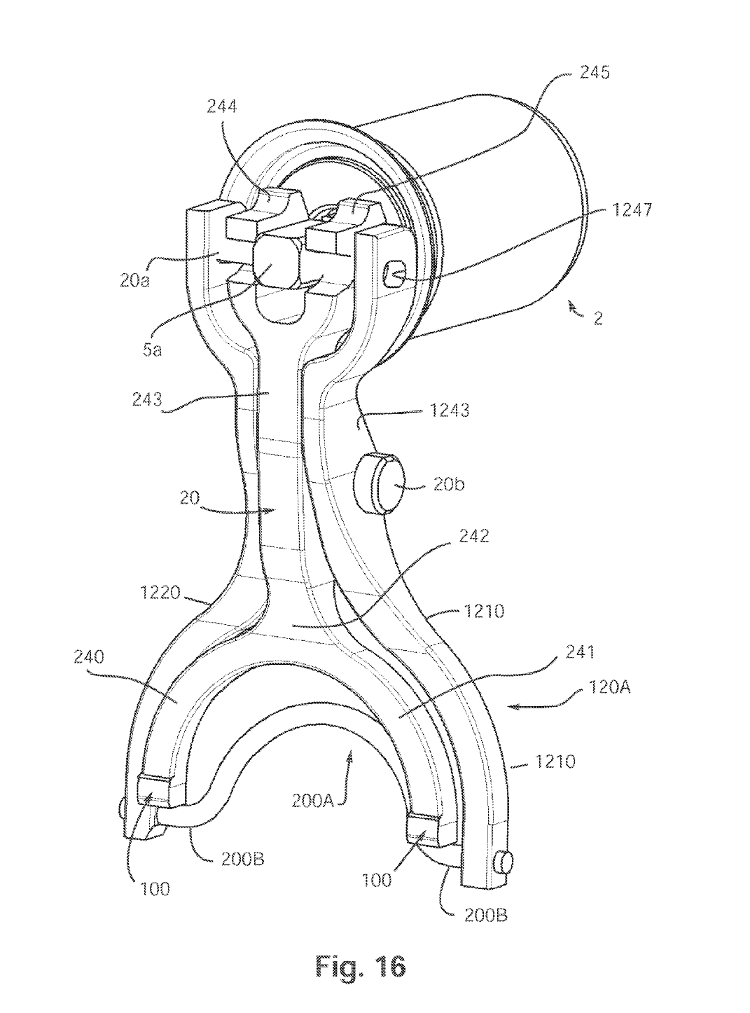

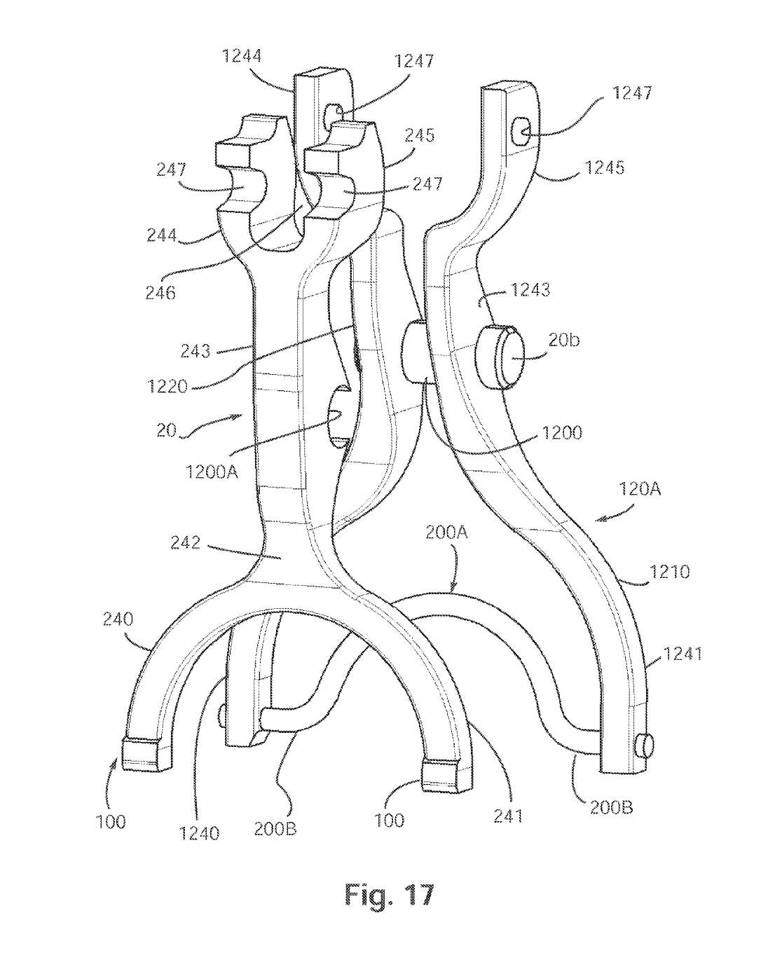

This element 200A may be attached to the lower extremity of additional lever 120A as may more particularly be seen in FIGS. 16 and 17.

The attachment of engaging member 200, 200A to control lever 20 and additional lever 120A respectively is an articulated attachment, articulation means being located between the engaging member and its associated lever.

This engaging member is configured to act with delay on drive element 118 and press the latter in the direction of reaction plate 112 to engage clutch 300. Lever 20 is configured in the aforesaid manner to act on aforesaid casing 112, 113, 114 and move the latter axially towards the advanced position of meshing with ring gear C. The casing is moved axially along axis X and shaft 24. Lever 20 is, as aforesaid, the first to act on the casing, before the tightening action exerted with delay by engaging member 200, 200A on drive element 118.

In FIGS. 3 to 13 this engaging member comprises an engaging yoke 200 for clutch 300.

According to one characteristic, yoke 200 is mounted with articulation on the fork-shaped lower extremity 240, 241, 242 of lever 20 (FIGS. 6 and 7). It is mounted in the fork at the lower extremity of that lever 20.

This yoke 200 may be open on its inner periphery (FIG. 7) for fitting in the groove 223 (FIGS. 4, 5 and 10) which is of one piece with drive element 118. Such assembly is easy; yoke 200, mounted in an attached way on lever 20, being inserted radially into groove 223 in the same way as lever 20 of a conventional starter.

As a variant, yoke 200 may be closed and be mounted in groove 223 through a mounting of the bayonet type. In all cases the opening in yoke 200 is oblong in shape and transverse in relation to the X axis to allow yoke 200 to move radially with respect to groove 223.

Groove 223 is bounded by two sides which are transversely orientated. Its cross-section is overall of a U shape.

One of the sides of groove 223 may be thicker than the other side as may be seen for example in FIGS. 4, 5 and 10. In these figures, it is the front side 224 of groove 223 which is the thicker.

Groove 223 may be formed by means of an annular member 123 of overall U-shaped cross-section attached to drive element 118, more specifically on the outer periphery of pinion 119. Member 123 and engaging yoke 200 may be of plastics material to reduce noise.

Yoke 200 is configured to act on the front side 224 of groove 223. It is capable of bearing against this front side 224, which is the thicker one, in two diametrically opposite areas.

With reference to FIGS. 4 and 10, it will be noted that side 224 partly penetrates the interior of ring 114. Its outside diameter is less than the inside diameter of the ring. This makes it possible to reduce the axial dimensions of starter drive unit 1.

Starter drive unit 1 according to the invention therefore comprises (see FIGS. 3 to 5) drive element 118 which is centrally hollow for the passage of portion 110 of output shaft 24 which is provided with helical grooves 28. This drive element 118 comprises behind it drive bush 119 provided internally on its inner periphery with helical grooves 29 of a shape matching helical grooves 28 in shaft 24.

Aforesaid washer 400 increases the rate at which grooves 29 unscrew from grooves 28.

As in FIG. 2, bush 119 is bounded at the front by a flange 120 which is transversely orientated in relation to the X axis of output shaft 24 of the starter partly illustrated in FIG. 3.

This shaft 24 has at the front a smooth portion 22 with a hollow (not referenced) for receiving the mounting rod of stop 25 in FIG. 1. In this embodiment of the invention bearing 124 is of one piece with metal pinion 11 of the centrally hollow starter drive unit. This bearing 124 acts against the outer periphery of portion 22 and the inner periphery of pinion 11 delimiting a cylindrical central bore through which portion 22 passes.

In the figures illustrated, annular member 123 which is designed to receive engaging yoke 200 for clutch 300 is force fitted on the outer periphery of bush 119. This member 123, of U-shaped cross-section, comprises an annular base axially oriented in relation to the X axis (not referenced in FIGS. 4 and 10) in contact through its inner periphery with the outer periphery of bush 119 and two sides transversely orientated in relation to that X axis. The front side is in contact with the rear surface of flange 120 through its front surface. This front side comprises the thicker side 224 of groove 223. Member 123 is chamfered at the front so as not to interfere with the joining rounding of the rear surface of flange 120 with the front end of bush 119. In FIGS. 4 and 10 there is a slot (not referenced) between the rear end of portion 121 and the front surface of flange 120 so that grooves 122 can be machined.

Flange 120 is here of annular shape. Its diameter is less than that of drive element 118 in FIGS. 1 and 2. The outside diameter of flange 120 is, according to one characteristic, greater than the outside diameter of member 123 comprising the outside diameter of its sides. Member 123 bears axially on flange 120.

According to one characteristic, in this embodiment, flange 120 comprises the aforesaid pressure plate of friction clutch 300 provided with at least one friction disc 301. This flange 120, which is of one piece with drive element 118, is implanted in casing 112, 113, 114.

This friction clutch 300 replaces the idling roller bearing in FIGS. 1 and 2. It comprises disengageable means of attachment between drive element 118 and pinion 11. It allows pinion 11 to rotate in both directions when the starter drive unit is in the advanced resting position.

In order to do this, the starter drive unit here has at the front a portion 121 provided with axially orientated grooves 122. This portion 121 penetrates within the cavity bounded by reaction plate 112 and skirt 113. It is therefore implanted in this cavity.

In the embodiments in FIGS. 3 to 13, disc 301 has on its inner periphery lugs which matchingly penetrate grooves 122.

Thus disc 301 is connected in rotation with drive element 118 through shape interaction with the possibility of axial movement. Reaction plate 112 extends parallel to flange 120.

The outside diameter of reaction plate 112 is larger than the outside diameter of flange 120.

Pinion 11 has an outside diameter which is larger than that of sleeve 111.

In the embodiment in FIGS. 3 to 11, pinion 11 is of one piece with sleeve 111, which is itself of one piece with reaction plate 112 which is extended on its outer periphery by cylindrical skirt 113. Skirt 113 is directed axially rearwards in the direction of flange 120. The inner periphery of skirt 113 extends parallel to portion 121 of drive element 118 at a radial distance from portion 121.

A cavity housing disc 301 is thus formed between skirt 113 and portion 121.

The outside diameter of disc 301 is smaller than the inside diameter of skirt 113, while the inside diameter of disc 301 is overall the same as the outside diameter of portion 121. The size of the inner lugs on disc 301 depends on the depths of grooves 122.

In this embodiment, as mentioned above, a friction disc 302 rotates as one with reaction plate 112 being adjacent to the rear surface of this plate 112.

In order to do this, skirt 113 has an excess thickness (not referenced) internally. Axial orientation grooves 322 are formed on the inner periphery of this excess thickness. Disc 302 has lugs (not referenced) on its outer periphery which matchingly penetrate grooves 322 for rotational connection to reaction plate 112 through shape interference with axial mobility.

The outside diameter of disc 302 is overall the same as the inside diameter of the excess thickness in skirt 113, while the inside diameter of disc 302 is overall the same as the outside diameter of portion 121. The size of the outer lugs on disc 302 depends on the depth of grooves 322.

The number of lugs on discs 301, 302 may be the same as the number of matching grooves 122, 322 respectively for maximum transmission of a torque. As a variant, the number of lugs may be less than the number of matching grooves 122, 322 when the torque which has to be transmitted is smaller.

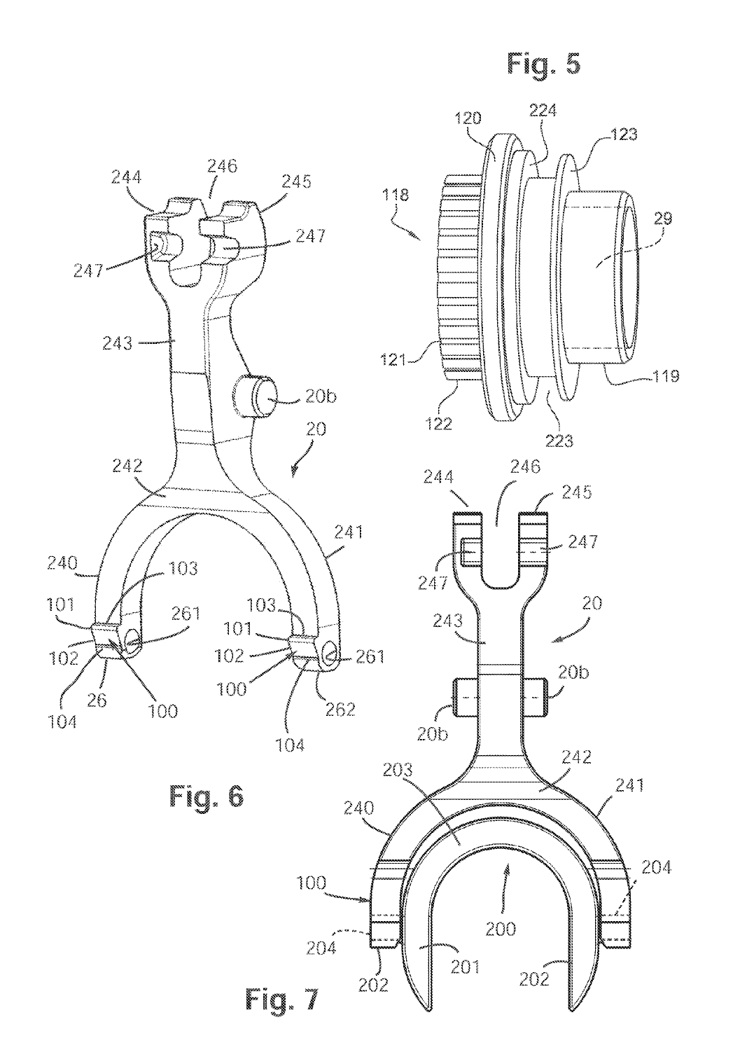

The lugs on discs 301, 302 and matching grooves 122, 322 may be of overall trapezoidal shape (FIG. 5).

In another embodiment the lugs on discs 301, 302 and matching grooves 122, 322 may be crescent-shaped, having an overall semicircular cross-section.

In yet another embodiment the lugs on discs 301, 302 and matching grooves 122, 322 may be of overall rectangular shape.

The number of discs 301, 302 may be increased to transmit a larger torque without increasing the diameter of starter drive unit 1. In the figures provision is made for two friction discs 301. As a variant, a greater number of friction discs 301, 302 may be provided.

Discs 301, 302 may be of the organic type, being obtained for example from a binder comprising at least one thermohardening resin and fillers, such as graphite, silica, metal powders and fibres, such as aramide fibres, for example Kevlar©.

As a variant, discs 301, 302 may be of the sintered type comprising metal powders such as copper and iron agglomerated under pressure at high temperature.

As another variant, discs 301, 302 may be of the metal type and comprise an alloy of for example copper or iron.

As yet another variant, discs 301, 302 may be metal and may be lined on each surface with a friction lining for example of the aforesaid type, that is to say organic or sintered.

Lugs 301, 302 of the discs are in this case of metal.

In the embodiments illustrated in the figures provision is made for three friction discs 302 and in an alternating fashion, two friction discs 301, the friction coefficient of disc 302 matching that of flange 120.

Discs 301 are each placed between two discs 302, one of which is adjacent to the rear surface of reaction plate 122. Disc 302 which is the furthest from plate 122, and referred to as the end disc, comprises a rear surface which faces the front surface of flange 120.

As may better be seen in FIGS. 3 and 4, skirt 113 is extended at its axial extremity furthest from plate 122 by a closing ring 114 which is transversely orientated in relation to the X axis.

According to one characteristic, control lever 20 is configured to come into contact with closing ring 114. Shoes 100 described below are present between casing 112, 113, 114 and the lower part of control lever 20. Shoes 100 may form part of the casing. As may be seen in these FIGS. 3 and 4, shoes 100 are part of control lever 20, being of one piece with that lever. They are supported by lever 20. In these figures, shoes 100 are configured to act on closing ring 114.

Ring 114 forms part of the casing comprising reaction plate 112 of one piece with sleeve 111 and skirt 113. This casing rotates as one with pinion 11, which may also be axially as one with sleeve 111 and this casing or as a variant move axially in relation to this casing in the manner described below.

Ring 114 is a ring closing this casing and is itself centrally closed by flange 120.

Flange 120, discs 301, 302 and washer 400 are placed in the casing before the latter is closed off by ring 114.

The rear surface of flange 120 may come into contact with the front surface of ring 114. In this case the outside diameter of flange 120 is larger than the inside diameter of ring 114.

As a variant, in order to reduce the axial bulk of starter drive unit 1, this ring 114 is excavated in an annular manner in its inner periphery. A change of thickness in ring 114 is thus produced in its inner periphery with the formation of a shoulder 115 transversely orientated in relation to the X axis. This shoulder 115 (FIG. 4) is bounded on its outer periphery by an annular bearing member 215 which is axially orientated in relation to the X axis with a connecting rounding between shoulder 115 and bearing member 215.

The front surface of shoulder 115 can act together with the rear surface of flange 120. The outside diameter of flange 120 is smaller than the inside diameter of bearing member 215 and larger than the inside diameter of ring 114. Shoulder 115 is therefore configured to act together with the outer periphery of the rear surface of flange 120.

Ring 114 is excavated in an annular manner in its outer periphery for mounting a cap 230 assembling ring 114 and skirt 113 with reaction plate 112. In this example, the excess thickness in skirt 113, which is provided to form axially orientating grooves 322, comprises an axial strut between ring 114 and reaction plate 112. This cap 230 is here of sheet metal and comprises an end with a central hole. This end (not referenced) is in contact with the front surface of plate 112 and is extended on its outer periphery through a bevel by an axially orientated annular skirt in intimate contact with the outer periphery of skirt 113. Cap 230, of annular shape, thus envelops skirt 113.

The inside diameter of the end of cap 230 is preferably the same as or larger than the outside diameter of pinion 11 so that cap 230 can be axially slipped onto skirt 113 with the end of cap 230 abutting against plate 112. The free end of cap 230 is then radially returned towards the interior to penetrate the excavation in the outer periphery of the ring and the attachment of skirt 113 with plate 122.

In a variant ring 114 is attached securely, for example by riveting, bolting, crimping or welding, such as transparency laser welding, to the free end of skirt 113 which in the aforesaid manner may be attached to the outer periphery of plate 112 or be of one piece with this plate 112. An assembly of the bayonet type may be provided between ring 114 and skirt 113. The presence of cap 230 is therefore not compulsory.

As in the figures, the outer periphery of skirt 113 is cylindrical. As a variant, the outer periphery of skirt 113 may not be cylindrical and may for example be of frustoconical shape.

The outside diameter of member 123 determined by the outside diameter of its sides, is smaller than the inside diameter of ring 114 of the casing.

The outside diameter of the sides of grooves 223 is therefore smaller than the inside diameter of ring 114.

It will be noted that, in accordance with one characteristic, the thickest side 224 of member 123 has an axial thickness which is greater than that of shoulder 115. In this embodiment, this thickness is larger than play J, as may better be seen in FIGS. 4 and 10.

The thickness of side 224 depends on applications. This thickness is decided upon in order to prevent any interference between engaging yoke 200 of the clutch and ring 114, in particular in the position in FIG. 11. Side 224 is allowed to move axially in relation to ring 114 in the direction of reaction plate 112 when moving from the position in FIG. 3 to the position in FIG. 11. It partly penetrates this ring 114 in the manner aforesaid. The thickness of side 224 is in this example smaller than that of ring 114. Everything depends on the application.

Groove 223 may as a variant include two sides, one of which comprises flange 120 comprising the pressure plate of clutch 300 and the other a washer attached to the rear end of the starter drive unit as in FIGS. 1 and 2. In this case, flange 120 is thicker towards the rear. This excess thickness and its diameter then correspond to those of branch 224.

As will be seen from the above, sleeve 111 is of one piece with the casing comprising reaction plate 112, skirt 113 and ring 114. This casing houses clutch 300 and flange 120 within it.

In the withdrawn resting position (FIG. 3), discs 301, 302 are not tightened so that clutch 300 is disengaged and there is the aforesaid axial play J (FIG. 4) between end disc 302 and flange 120.

This axial play is present between end friction disc 302 and flange 120 when moving assembly 500 of starter drive unit 1 and control lever 20 are in the withdrawn resting position corresponding to that in FIGS. 1 and 2; starter drive unit 1 is then at a distance from stop 25 in FIG. 1 and from starter toothed ring gear C of the heat engine.

According to one characteristic, in the aforesaid manner, in order to better ensure axial play J a resilient washer 400, which acts axially, is here placed between the front surface of drive element 118 comprising the front surface of portion 121 and the rear surface of plate 112.

This washer 400 pushes drive element 118 rearwards and facilitates the detachment of drive element 118 screwed onto grooves 28 of shaft 24 and the speed with which it is detached. This washer 400 reduces noise because it prevents any contact between drive element 118 and reaction plate 112 when moving assembly 500 is in the withdrawn resting position. It is compressed when moving assembly 500 is in the advanced position.

The strength of washer 400 is small. It develops minimal force in comparison with that developed by tooth-against-tooth spring 5.

Washer 400 here comprises a waved washer of the onduflex type which is housed in an annular groove 401 provided in the rear surface of reaction plate 112 on the inner periphery of that plate 112, which has reduced thickness at the location of this groove 401 which opens in the direction of drive element 118. This washer 400 is axially compact and exerts an overall constant force on flange 120. Portion 121 has an annular projection (not referenced) at its forward end which can penetrate within washer 400 for satisfactory positioning of the latter. As a variant, washer 400 is replaced by a Belleville washer or a diaphragm in the form of a Belleville washer having lugs on its inner periphery, even a coil spring.

Lever 20 (FIGS. 6 and 7) has at its upper extremity two lugs 244, 245 which are separated from each other by a slot 246 for passage of the front end of rod 5a in FIG. 1. Each lug 244, 245 has an excavation 247 to receive the upper articulation axis 20a in FIG. 2, this axis passing through rod 5a.

Rod 5a and axis 20a belong to contactor 2 and therefore to means for manoeuvring the upper extremity of lever 20.

This lever 20 also has a lower fork-shaped extremity 240, 241, 242 and a connecting portion 243 connecting the upper extremity to the lower extremity of lever 20.

Connecting portion 243 is overall of constant width between the extremities of the lever. This portion 243 bears a cylindrical pivot 20b laterally on each of its surfaces. These pivots 20b are each intended to penetrate within an oblong hole formed in the branches comprising support 36 in FIG. 2. Pivots 20b comprise the intermediate articulation axis for lever 20. The width of portion 243 depends on the spacing between the branches of support 36.

This arrangement allows lever 20 to pivot.

The lower extremity of lever 20 comprises two arms 240, 241 connected by a rounded connecting part to portion 243.

Lever 20 is therefore a pivoting control lever comprising an upper extremity which is capable of being moved by manoeuvring means forming part of the starter and also a fork-shaped lower extremity comprising two arms 240, 241.

Engaging yoke 200 of clutch 300 is housed in the lower extremity of lever 20, between arms 240, 241. Yoke 200 is mounted with articulation between arms 240, 241.

It is configured to act in a differential way on drive element 118 comprising the driver for the clutch, and presses this in the direction of reaction plate 112 to engage clutch 300.

This yoke 200 is open at its lower extremity to form two branches 201, 202 connected together by an outer portion 203 which extends for a distance from rounded part 242.

Portion 203 is rounded in this embodiment. It may be of a trapezoidal or other shape.

As a variant, when yoke 200 is closed up, it comprises two branches 201, 202 connected by an outer rounded portion and also by an inner rounded portion.

The edges of the branches are parallel.

Branches 201, 202 are separated from each other by a distance which overall corresponds to the outside diameter of the base of groove 223. In the figures this base of groove 223 corresponds to that of member 123 which is to be mounted on the latter and bears on two diametrically opposite parts on side 224 of this member 123 having an annular groove 223.

Branches 201, 202 are mounted with axial play in groove 223 of member 123 to have a delayed action on drive element 118.

Each branch 201, 202 has laterally a projecting pivot 204 which can penetrate in a matching way within a cylindrical hole 261 in the lower extremity of each arm 240, 241.

Of course, as a variant, the structures may be reversed, the projecting pivots each forming part of an arm 240, 241 while the holes are each formed in branches 201, 202. One of the associated branch/arm elements has a pivot 204 which penetrates a hole 261 forming part of the other of the associated arm/branch elements.

Preferably there may be small radial play between pivot 204 and its associated hole 261 for better uncoupling of the force exerted by lever 20 on ring 114 in comparison with the delayed force exerted by yoke 200 on the front side 224 of groove 223 of drive element 118.

Through holes 261 and pivots 204 yoke 200 is mounted on the lower extremity of lever 20 in an articulated manner between arms 240, 241 of that extremity, and therefore provides an attachment between this yoke 200 and the lower extremity of lever 20.

The articulation is provided for each branch 201, 202 at the lower extremity of associated arm 240, 241.

The lower extremity of each arm 240, 241 comprises a rounded area 262 extending outwards, in one characteristic through a projecting shoe 100 configured according to one characteristic to form externally a cam which can come into contact with casing 112, 113, 114 to move the latter towards the position in which pinion 11 engages ring gear C along the axial X axis of symmetry of starter drive unit 1.

More specifically, in this embodiment each shoe 100 is of one piece with the corresponding arm 240, 241 of lever 20 and is configured to come into contact with closing ring 114, more specifically with the rear surface of this ring 114.

Shoes 100 project axially in relation to the front surface of lever 20. As may be seen in FIGS. 3, 6, 8, 9, 11, these cam-shaped shoes 100 each have a summit portion 101 which is extended at its inner periphery by an inclined disengaging portion 102 extending in the direction of a flat portion 104 which is connected to rounded part 262. This portion 101 is flat overall. This flat portion 101 may be parallel to the rear surface of corresponding arm 240, 241 and be bounded on its outer periphery by a portion 103 which is overall perpendicular to corresponding arm 240, 241. Holes 261 and pivots 204 are implanted in portions 104 and parts 262 as may be seen in FIGS. 3, 8, 8, 11. Each cam therefore has portions 101, 102, 103.

Shoes 100 carried by lever 20 are capable of coming into contact with their summit portion 101, that is to say bear against, closing ring 114 in two diametrically opposite parts of the latter.

The spacing between arms 240, 241 therefore depends on the inside diameter of ring 114.

All these shapes are easily obtained when yoke 200 and lever 20 are obtained by moulding.

Thus lever 20 and yoke 200 may be of plastics material to reduce noise and for ease of assembly.

Shoes 100 may be of one piece with lever 20.

As a variant, lever 20 and yoke 200 may be of metal, for example based on aluminium. In this case, member 123 is advantageously of metal.

As a variant, pivots 204 may be attached. They may be of a different material from that of lever 20 or closing piece 200.

As a variant, shoes 100 may be attached to the lower extremity of lever 20. They may be of a different material from that of lever 20.

The plastics material may be reinforced by fibres.

Likewise as a variant shoes 100 may be attached to arms 240, 241.

Moving assembly 500 enables pinion 11 to engage with ring gear C before the latter has completely stopped rotating.

It also enables pinion 11 to mesh with ring gear C when the pistons return to their resting positions and during oscillating phenomena.

This moving assembly 500 is equipped as aforesaid with a pinion 11, which can rotate clockwise and anticlockwise.

Moving assembly 500 operates as follows.

In FIG. 3 this assembly 500 is in the withdrawn resting position corresponding to that in FIGS. 1 and 2. There is axial play between branches 201, 202 and side 224.

In this position drive element 2 in FIGS. 1 and 2 is not electrically powered.

Starting from this position, in the aforesaid manner, electrical power is provided to the coil or coils 2a of drive element 2 in FIGS. 1 and 2.

The electrical feed to drive element 2 creates a magnetic field and axially displaces moving core member 2b in the direction of fixed core 2f, the said moving core member 2b acting on the upper extremity 244, 245 of lever 20 via axis 20a engaged in recesses 247.

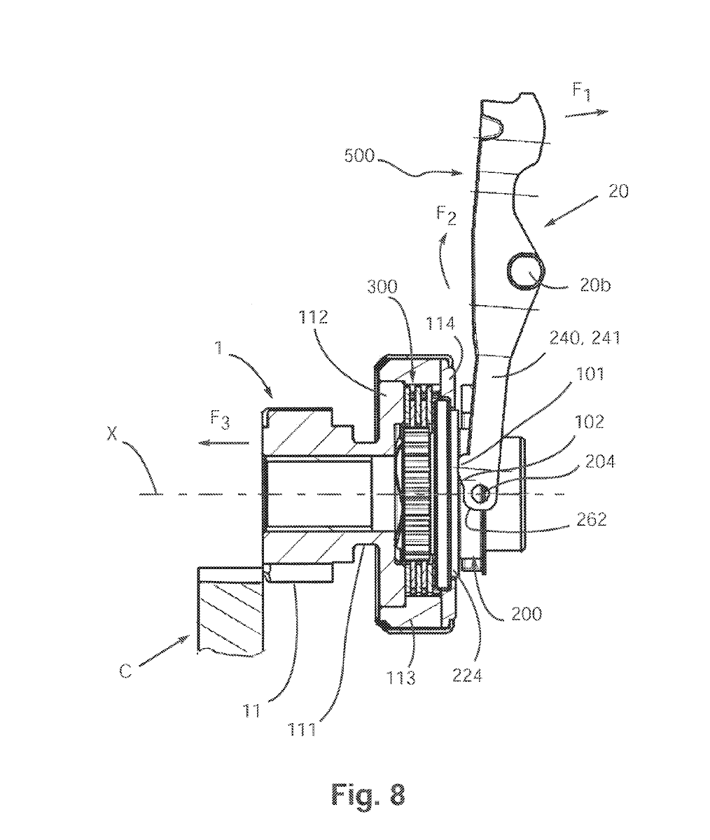

The upper extremity 244, 245 of lever 20 is then moved overall axially in accordance with arrow f1 in FIG. 8 with lever 20 pivoting in support 36 via pivots 20 comprising the intermediate articulation axis for lever 20 in support 36, in a clockwise direction.

Thus in a first stage (movement from the withdrawn resting position in FIG. 3 to the position in FIG. 8) shoes 100 act via their summit portions 101 on ring 114 of casing 112, 113, 114 which then moves sleeves 111 and pinion 11 axially in the direction of ring gear C along shaft 24 in the direction of arrow f3 in FIG. 8. Bearing 124 slides on shaft 24.

During this stage clutch 300 is disengaged so pinion 11 is free to rotate in both directions and lever 20 pivots through pivots 20b in a clockwise direction in support 36 in FIGS. 1 and 2 in the direction of arrow f2 in FIG. 8. As the axial movement continues pinion 11 arrives in the vicinity of ring gear C (FIG. 8).

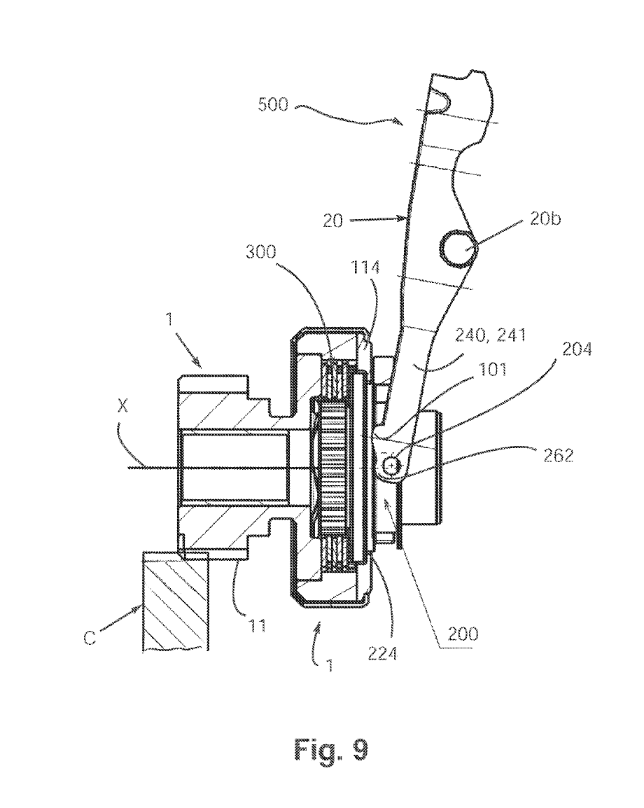

In a second stage (movement from the position in FIG. 8 to the position in FIG. 9) pinion 11, which is free to rotate, penetrates slightly within ring gear C and yoke 200 closing clutch 300 comes into contact with side 224 of member 123 bounding groove 223 after taking up the axial play.

During this second stage rounded parts 262 approach ring 114 and therefore side 224 to come into contact with ring 114, while summit portions 101 move away from ring 114 and side 224.

At the same time yoke 200 is displaced axially towards side 224 to come into contact with the latter and axially move drive element 118 and the latter's flange 120 in the direction of reaction plate 112. Washer 400 is then compressed and the play J between end disc 302 is eliminated. The clutch is then progressively engaged to transmit torque from pinion 11 to starter toothed ring gear C.

It will be noted that pivots 204 and holes 261 are axially moved towards side 224 when passing from the position in FIG. 8 to the position in FIG. 9. During this movement the radial play between holes 261 and pivots 204 is taken up. This radial play is present in the position in FIG. 9 between the inner periphery of the pivot and the inner periphery of the associated opening 261. In the position in FIG. 8 this play is present between the outer periphery of the pivot and the outer periphery of associated hole 261. The radial play is for example less than 0.5 mm. In the figures it is overall 0.35 mm.

In FIGS. 3 and 8 the axis passing through the centre of pivots 204 and holes 261 intercepts the X axis. This axis then moves radially in relation to the X axis, in an outward direction.

Thus in a third stage (movement from the position in FIG. 9 to the advanced engaging position in FIG. 11) the axial movement of pinion 11 and the pivoting of lever 20 continuing, shoes 100 are retracted, clutch 300 is engaged and torque is transmitted from pinion 11 to ring gear C. Pinion 11 penetrates fully within ring gear C to mesh with it (FIG. 11) and yoke 200 moves radially outwards while continuing to slide along side 224 without contact with ring 114 because of the thickness of side 224. Pivots 204 and holes 261 also move radially outwards. Washer 400 is compressed.

Of course the length of branches 201, 202 is dimensioned on the basis of applications so that these branches 201, 202 remain in contact with two diametrically opposite parts of side 224.

When ring gear C rotates faster than shaft 24 the clutch is released because drive element 118 performs a rearward axial movement because of the link between drive element 118 and shaft 24 via grooves 29, 28. Drive element 118 unscrews itself. This action is amplified by washer 400 which relaxes and pushes drive element 118 rearwards.

If it jams the clutch slips and acts as a torque limiter.

Pinion 1 cannot penetrate ring gear C. As mentioned previously, the tooth-against-tooth spring is then compressed.

In order to limit impacts and noise provision is made according to another embodiment of the invention for mounting pinion 11 so that it can move axially in relation to sleeve 111. In order to achieve this there is a matching grooved assembly 422 between the outer periphery of sleeve 111 and the inner periphery of pinion 11 which is separate from sleeve 111. This assembly creates a rotational link between pinion 11 and sleeve 111 which is integral with casing 112, 113, 114.

Grooves 422 here have an axial orientation which is contrary to matching helical grooves 28, 29.

Pinion 11 is extended rearwards by an axially orientated cylindrical wall 452 which together with the outer periphery of sleeve 111 bounds a cavity housing a resilient member 451, here a coil spring 451. This spring 451 bears at one of its axial extremities on the base of this cavity comprising the connecting part between wall 452 and the inner periphery of pinion 11. The other axial extremity of spring 451 bears against the front surface of reaction plate 112.

Wall 452 guides spring 451. A groove 453 is provided at the rear axial extremity of sleeve 111 adjacent to plate 112 so that the grooves can be machined in the outer periphery of sleeve 111, which is here of one piece with plate 112.

The inner periphery of the front extremity of pinion 11 is recessed to form a housing 456 for a Circlip© 452 axially holding pinion 11. This circlip is mounted in a groove 454 machined in the front extremity of sleeve 111. In the resting position of the starter drive unit (FIG. 12) spring 451 presses pinion 11 in the direction of circlip 450 which comprises an axial stop which then bears against the shoulder formed by the base of housing 456.

When pinion 11 abuts against ring gear 111 and does not penetrate within it (FIG. 13) spring 451 is compressed and pinion 11 moves rearwards in the direction of reaction plate 112 so that impacts and noise are minimised.

Spring 5 in FIG. 1 is then compressed until moving contact 3a engages the heads of terminals 3e, 3f and causes electric motor M to rotate, enabling pinion 11 to penetrate the ring gear in a known way.

The stiffness of spring 451 is greater than that of resilient washer 400, while less than that of spring 5.

It will be noted in FIGS. 3, 8, 9, 11 that resilient washer 400 is mounted in an annular groove formed in a reduction in thickness in the inner periphery of reaction plate 115. A shoulder which is transversely orientated in relation to the X axis is thus formed. This shoulder is bounded at its outer periphery by an annular bearing member which is axially orientated in relation to the X axis. This bearing member comprises a centering bearing member for the outer periphery of resilient washer 400 which is of a waved shape in these figures. The groove opens centrally for the passage of output shaft 24.

FIGS. 4 and 10 illustrate a variant of groove 401 housing washer 400. This groove 401 opens axially in the direction of drive element 118 and comprises a transversely orientated base and two axially orientated parallel sides. In all cases reaction plate 112 is excavated on its inner periphery to house washer 400, which makes it possible to reduce the axial dimensions.

As a variant, reaction plate 112 is of constant thickness and has an axially orientated cylindrical wall to house washer 400.

Thanks to the invention, as is apparent from the description and the drawings, as starter drive unit 1 begins to move, pinion 11 can rotate in both directions so that it constitutes an idling pinion.

A mechanical synchroniser is produced—idling pinion 11 can penetrate within ring gear C when the latter is rotating such that the rotation speed of pinion 11 matches and synchronises with that of ring gear C. This penetration within the ring gear may occur even if the latter is rotating in the reverse direction.

A two-stage operation is brought about.

In the first stage cam-shaped shoes 100 act on ring 114 which is connected at least in rotation with pinion 11, which is then free because it can idle during this first stage. Pinion 11 is moved axially via ring 114 and can therefore engage with ring gear C without resistance, knowing that clutch 300 is then disengaged.

When pinion 11 has penetrated a few millimetres within the ring gear (FIG. 9), the second stage takes place. Of course this depends on the thickness of discs or discs 301, 302.

In the second stage shoes 100 stop pushing on ring 114 and yoke 200 acts on side 224 of groove 223 and moves drive element 118 and flange 120 thereof in the direction of reaction plate 112, which progressively engages clutch 300 and therefore progressively tightens friction disc or discs 301, 302 against reaction plate 112 and the pressure plate comprised of flange 120 to transmit torque from the electric motor to starter ring gear C of the heat engine's starter. Progressive engagement is encouraged by washer 400 which ensures that there is play between end disc 302 and flange 120.

During this second stage yoke 200 moves radially. It acts differentially on drive element 118 of starter drive unit 1 in relation to the force exerted by shoes 100 on the casing of starter drive unit 1.

Clutch 300 engages faster than conventional friction clutch starters. Discs 301, 302 are held together during compression.

The clutch cannot disengage, the pressure within the clutch being maintained by yoke 200. Furthermore, because the yoke is mounted in groove 223, clutch 300 closes more quickly.

Thanks to the invention the restarting time for the heat engine, impacts and noise are reduced. The time between two successive restarts of the heat engine can be reduced.

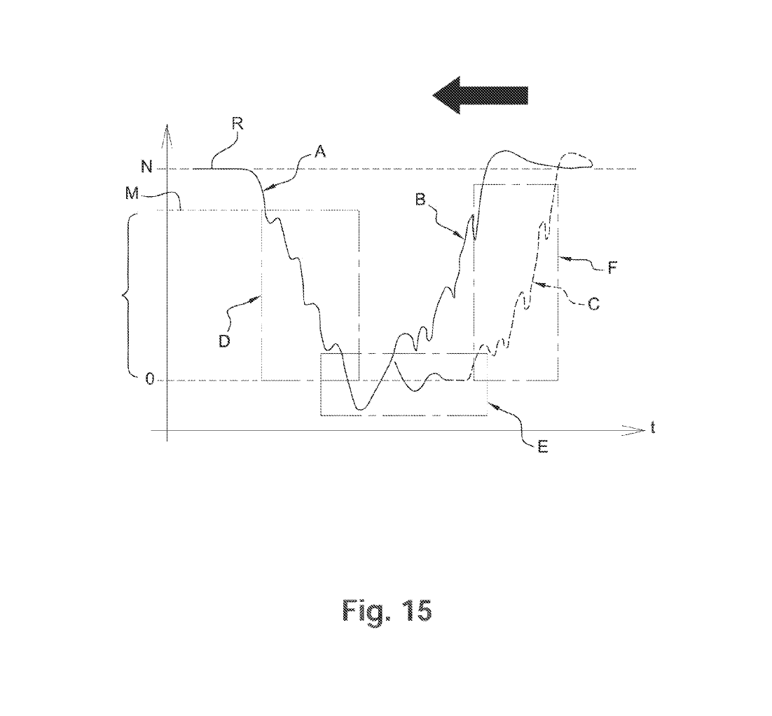

For this, reference should also be made to FIG. 15 in which the ordinate N of graphs A, B, C corresponds to the rotation speed of the heat engine in rotations per minute and the abscissa t to time.

In this FIG. 15 reference R corresponds to the idling regime of the heat engine, overall of the order of 750 rpm for a diesel engine, reference M corresponds to the minimum restarting rotation speed for the heat engine (independent running condition) and rectangles D, E and C to different windows enclosing parts of the graphs.

Graph A corresponds to the aforementioned conventional graph for a heat engine when it is stopped.

In this case the rotation speed decreases (window D) and, as explained in the introduction, vibration and oscillation phenomena occur (window E), due in particular to reverse rotation when one or more pistons descend before the heat engine comes to a complete stop with its pistons in a specified position.

Normally, as described in document EP 1 462 645, it is necessary to wait until the heat engine is completely stopped before it can be restarted in accordance with the characteristic graph included in window F. Graph B corresponds to a characteristic restarting graph in which the first vibration included in window E is prolonged.

The heat engine can be restarted on the basis of graph B after it has changed to a positive rotation speed in window E. This graph B is offset in relation to graph F in respect of time. It precedes graph F in time. Of course the heat engine can be restarted in window D.

Thanks to the invention it is not necessary to wait for the heat engine to stop completely.

In fact, in the aforesaid manner, pinion 11 can penetrate within ring gear C in this window E. It can also penetrate ring gear C when it is still rotating in window D.

It will be seen that the restarting time is shortened, and is so using a mechanical system.

Of course, the invention is not restricted to the embodiments described above.

Thus as a variant bush 124 is replaced by two needle roller bearings 124′ as may be seen in FIG. 14.

As a variant bush 124 is replaced by a lubricated bearing and by another bearing such as a needle roller bearing.

The presence of sleeve 111 is not compulsory.

Flange 120 may abut directly against the front surface of ring 114 so that there is no need for internal recess 115, 215 in ring 114.

Skirt 113 is in one variant axially extended rearwards in the direction away from pinion 11. This skirt 113 bears internally a ring such as a circlip or other arrangement forming the stop shoulder for flange 120. In this case projecting shoes 100 are intended to bear against the free end of skirt 113. This axial prolongation is for example equal to at least the thickness of closing ring 114 in the preceding figures, the outside diameter of which is smaller.

The axial prolongation of skirt 113 may be further increased, as may be the thickness of side 224. Thus a change in diameter may be provided at the free extremity of skirt 113 to reduce the thickness of that skirt and create an annular support shoulder for shoes 100.

Through its shoes 100 lever 20 can therefore bear on an annular shoulder which is axially offset in the direction of pinion 11 in relation to the free end of skirt 113 which bears a closing shoulder internally.

In all situations shoes 100 act on the casing compressing reaction plate 112 and skirt 113.

As a variant the means for engaging the clutch include an engaging part 200A associated with an additional lever 120A.

In this case moving assembly 500 is provided with a double lever comprising control lever 20 and an additional lever 120A, as may be seen in FIGS. 16 and 17.

Lever 20 is intended to move the casing as in FIGS. 3 to 13, whereas additional lever 120A is intended to move the pressure element of the clutch via engaging member 200A attached through articulation to the lower extremity of additional lever 120A.

This additional lever 120A is configured in the manner described below to permit control lever 20 to be mounted in an articulated way between the upper and lower extremities of the latter.

Cylindrical pivots 20b belong to additional lever 120A.

This additional lever 120A comprises two parts 1210, 1220, each of which bear a pivot 20b.

These parts 1210, 1220 are connected to each other by a cylindrical strut 1200 mounting lever 20 with articulation between the upper and lower extremities of this additional lever 120A.

Strut 1200 is implanted in the extension of pivots 20b which indirectly constitute the intermediate articulation axis for control lever 20.

As in FIGS. 6 and 7, lever 20 controlling movement of the casing has an upper extremity 244 to 246, a lower fork-shaped extremity 240 to 242, and a connecting portion 243 connecting the upper extremity of the lever to the lower.

The upper part of this lever 20 is not modified in comparison with that shown in FIG. 6 and therefore comprises two lugs 244, 245 separated from each other by a slot 246 for the passage of rod 5a in FIG. 1. Each lug 244, 245 comprises a recess 247 to receive axis 20a.

The lower part of the lever is similar to that in FIG. 6 and therefore comprises two arms 240, 241 connected by a rounded portion 242 connecting to connecting portion 243. Each arm has a shoe 100.

This lower extremity 240 to 242 does not include any holes because engaging member 200A of the clutch is articulatedly connected to the lower extremity of additional lever 120A.

Connecting portion 243 is similar to that in FIG. 6. The difference lies in the fact that this part includes a groove 1200A for articulated mounting on cylindrical strut 1200.

Groove 1200A is open so that it can be snap-fitted to strut 1200. The size of groove 1200A matches the outside diameter of strut 1200 so that portion 243 and therefore lever 20 can be articulatedly mounted on strut 1200.

The two parts 1210, 1220 of lever 120A comprise flanges. Each flange 1210, 1220 has a lower extremity, an upper extremity and a connecting portion 1243 between the lower extremity and the upper extremity.

Thus additional lever 120A comprises a connecting portion 1243 in two parts separated by cylindrical articulation strut 1200 which sets the distance between these two parts. According to one characteristic, connecting portion 243 of lever 20 is located between the two parts of connecting portion 1243 of additional lever 120A so that the distance between the two connecting portions of lever 120A at the location of strut 1200 depends on the thickness of connecting portion 243 of lever 20. There is assembly play between the two parts of connecting portion 1243 of lever 120A and the intercalary connecting portion of connecting portion 243 of control lever 20.

The upper extremity of each flange 1210, 1220 comprises a lug 1244, 1245 which is offset in relation to connecting portion 1243 bearing pivot 20b. Lugs 1244, 1245 are each provided with an oblong hole 1247 which is penetrated by the corresponding extremity of axis 20a.

The lower extremity of each flange respectively comprises an arm 1240, 1241. Each arm 1240, 1241 comprises a hole (not referenced) to receive an axis 200B of engaging member 200A of clutch 300. This piece 200A is bow-shaped and articulatedly mounted between arms 1240, 1241 by means of an axis 200B which carries the bow at each of its extremities. Bow 200A is of semi-circular shape and therefore extends circumferentially over 180° overall.

Shoes 100 and arms 240, 241 extend over axes 200B. It will be noted that additional lever 120A has no connecting part between arms 1240, 1241 at its lower extremity.

Lever 20 is located within additional lever 120A; arms 1240, 1241 match the shape of arms 240, 241, while lugs 1244, 1245 are parallel to lugs 244, 245 respectively. Portion 243 is housed in connecting portion 1243. Assembly play is of course present.

Control lever 20 is therefore mounted in an imbricated way in additional lever 120A in a pivoting way between its lower and upper extremities by means of strut 1200.

Initially rod 5a moves axis 20a and lever 20 pivots about strut 1200A to act via shoes 100 on the casing to move pinion 11 as in FIGS. 3 to 13.

After the play that is present between the extremities of axis 20a and holes 1247 has been taken up, additional lever 120A is operated and pivots in support 36 in FIGS. 1 and 2 by means of pivots 20b.

Engaging member 200A then acts on side 224 and moves drive element 118 to tighten clutch 300 as in FIGS. 3 to 13. Engaging member 200A acts with delay via lever 120A after taking up the play between axis 20a and the front edges of holes 1247. This member 200A is therefore attached in an articulated way to the lower extremity of additional lever 120A which is configured to act with delay after lever 20.

In this embodiment the means for engaging the clutch comprise an additional lever 120A pivoting by means of pivots 20b comprising of the one part an upper extremity 1244, 1245 which is capable of being moved after play has been taken up by manoeuvring means 20a, 5a forming part of a starter and of the other part a lower extremity comprising two arms 1240, 1241 configured for articulated mounting of an engaging member 200A which can act in a delayed way on drive element 118 to displace the pressure element of the clutch axially via drive element 118 and press drive element 118 in the direction of the reaction plate to tighten clutch 300. The means for operating additional lever 120A comprise the means for operating control lever 20.

It follows from the above that additional lever 120A comprises two flanges 1210, 1220 which match the shape of control lever 20 located between the two flanges 1210, 1220. These two flanges 1210, 1220 are separated from each other between their lower and upper extremities by a cylindrical strut 1200 providing an articulated mounting for control lever 20.

Levers 20, 120A may be of plastics material.

Flanges 1220, 1210 may be of one piece with strut 1200 and pivots 20b.

Lever 20 may be of metal and lever 120A may be of plastics material.

Strut 1200 may be of one piece with flanges 1220, 1210 or may be attached to flanges 1210, 1220.

In all cases shoes 100 may be of one piece with lever 20 or attached to it.

As a variant, the structures may be reversed. Thus in a variant shoes 100 may be borne on the casing of starter drive unit 1. These shoes 100 then each act together with the corresponding arm of control lever 20.

The shoes belong to closure ring 114 or skirt 113 according to circumstances.

In the abovementioned embodiments there are articulation means between control lever 20 and engaging means 200-200A, 120A of friction clutch 300.

In FIGS. 3 to 13 these means include holes 261 and pivots 204 and in FIGS. 16 and 17 they comprise groove 1200A and strut 1200 together with axes 200B and the holes receiving these axes made in arms 1240, 1241. As a variant, arms 1240, 1241 have axes 200B which are received in holes in engaging member 200A.

Friction clutch 300 is, as previously stated, a variant of the frustoconical type as described in document WO 2006/100353.

Thus the friction disc or discs are replaced in a variant by a friction lining having an outer frustoconical periphery comprising the friction element anchored in the front part of the starter drive unit, comprising the pressure element, passing through the closure ring of one piece with a skirt forming part of a cap attached to a protuberance on the reaction plate on the inner periphery of frustoconical shape to act together with the outer periphery of the friction lining. The retaining ring which is of one piece with this skirt is advantageously ribbed in order to be stiffened.

The outer protuberance of the reaction plate is in a variant extended axially rearwards to constitute the skirt, on the free extremity of which the closing ring of the clutch is attached. Resilient washer 400, then mounted in an annular groove made in the transverse part of the reaction plate, makes it possible to detach the friction lining which abuts against the retaining ring in the resting state. The starter drive unit may be of plastics material and comprise the groove receiving the engaging yoke and the retaining ring. The friction element may be of filled fibre-reinforced plastics material.

The friction element is therefore in all cases at least partly housed in the casing delimited by the closing ring.

The friction disc may therefore be transversely orientated in relation to the X axis with a front face parallel to its rear face as in FIGS. 3 to 13. In this case at least one of these front and rear faces constitutes a friction surface of clutch 300. As a variant, the friction surface may comprise the outer periphery of the friction lining.

The invention applies to all types of starter which are normal for heat engines.

Thus the pinion of the starter drive unit may pass through the front bearing and extend beyond the casing as described in documents FR 2 677 710, U.S. Pat. No. 4,895,035 and FR 2 738 599.

In this case sleeve 111 is extended and bearing means, such as a ball bearing, are placed radially between the outer periphery of the sleeve and casing 18 as may be seen in these documents. Stop 25 may be attached to the free extremity of shaft 24 or be implanted in the vicinity of that free extremity of shaft 24.

The pinion of the starter drive unit may, as in the aforesaid manner, engage with a starter ring gear which is externally toothed as in FIG. 1 or internally toothed as in document FR 2 858 366. As a variant, transmission of the movement described in document FR 2 858 366 may be replaced by a chain transmission between a toothed wheel which is of one piece with the crankshaft and a toothed wheel forming part of the starter and of one piece with the internally toothed starter ring gear. As a variant, a gear transmission may be located between a toothed wheel which is of one piece with the crankshaft and a toothed wheel forming part of the starter and of one piece with the starter ring gear which can engage with the starter drive unit. In all cases starter ring gear C is directly or indirectly connected to the crankshaft of this heat engine.

As aforesaid, the output shaft of the starter may be the same as the output shaft of the electric motor or be separate from the latter, and the two output shafts may be coaxial or offset.

Two reduction gears, namely of the epicycloidal train type, may be provided as described in document FR 2 858 366.

A torque limiter and/or a torsion damper may be associated with the reduction gear as described for example in document FR 2 803 345.

The control lever may be mounted to pivot on a bearing, preferably of plastics material, comprising a first bearing part borne by the front bearing of the casing and a second complementary part formed matchingly in a supporting piece of the lever comprising a transverse annular ring which acts together with a front part of the activating element as described in document WO 01/31195.

As a variant, the lever may be pivotally mounted on an extension of the toothed ring gear of the reduction gear shaped to ensure a lever articulation function as described in document WO 2005/054664.

Tie rods may assemble the rear bearing to the front bearing of the casing, tightening the bush between these bearings as in aforementioned documents WO 2005/054664, FR 2 631 094 and FR 2 858 366.

The stator of the electric motor may comprise a winding as in document WO 98/329966 or permanent magnets.

The number of brushes may be increased as described for example in document FR 2 934 434, particularly when the starter must perform the Stop & Start function which makes it possible to stop the heat engine because of traffic conditions, such as when stopping at a red light or in a traffic jam, and then to restart the heat engine to reduce fuel consumption.

The contactor may be located above the electric motor of the starter as in FIG. 1 or be located away from it, being for example mounted transversely behind the electric motor of the starter via a return mechanism as described in document FR A 2 843 427.

In the light of document WO 98/32966 it will be seen that the contactor may comprise a hold-in coil and a pull-in coil.

As a variant, the contactor has only one coil as described in document FR A 2 795 884.

As a variant, the supporting shoulder for the rear face of moving contact 3a may be of another shape and belong for example to an assembly of the bayonet type as described in document FR 2 895 143, in particular when the starter must perform the Stop & Start function, or a snap-fit assembly between the central opening of contact 3a and rod 3 as described in document FR 2 767 960.

The assembly of the bayonet type may be applied to engaging yoke 200. In this case the other side of groove 223 opposite side 224 may comprise two flat surfaces for the passage of yoke 200 comprising two matching flat surfaces and hence the yoke rotates in the base of groove 23, the distance between the two flat surfaces of the yoke depending on the outside diameter of the base of the groove. This also applies to side 224.

As a variant, the means for manoeuvring the control lever may comprise a moving core electromagnetic contactor to manoeuvre the control lever and another electromagnetic contactor to manoeuvre the control rod and the moving assembly.

As a variant, the means for manoeuvring the control lever may comprise an electric motor drive acting for example through a mechanical linkage of the rack type on the moving core which comprises within it the tooth-against-tooth spring attached to a rod as in FIG. 1.

The heat engine may be fixed or be part of a motorised vehicle, such as a saloon car or a boat.

1. A moving starter drive unit (1)/control lever (20) assembly (500) which can move between a withdrawn resting position and an advanced position to mesh with a starter toothed ring gear (C) of a heat engine of a type comprising:
a starter drive unit (1) provided with a pinion (11) to mesh with the starter toothed ring gear and an axial axis of symmetry (X);
a drive element (118) forming part of the starter drive unit (1);
a friction clutch (300) located between the drive element (118) and the pinion (11), said clutch being provided with a reaction plate (112), a pressure element (118, 120) of one piece with the drive element (118) and at least one friction element (301) which can be tightened between the reaction plate (112) and the pressure element (118, 120);
wherein the pressure element (118, 120) is located at least partly within a casing (112, 113, 114), of the one part, which is of one piece in rotation with the pinion (11) and, of the other part, comprising a plate (112) comprising the reaction plate of the friction clutch (300);
a pivoting control lever (20) comprising, of the one part, an upper extremity (244, 245) which is capable of being moved by manoeuvring means (2) forming part of a starter (4) and, of the other part, a fork-shaped lower extremity (240 to 242) comprising two arms (240, 241) for acting on the starter drive unit (1);
wherein the control lever (20) is associated with engaging means (200-200A, 120A) for the friction clutch (300);
wherein articulation means are located between the control lever (20) and the engaging means (200-200A, 120A) of the friction clutch (300),
and wherein the control lever (20) is configured to enable the casing (112, 113, 114) to initially move axially along the axis of axial symmetry (X) towards the advanced position of meshing with the starter ring gear (C), while the engaging means (200-200A, 120A) of the friction clutch (300) are configured so that secondly they move the drive element (118) axially in the direction of the reaction plate (112) to tighten the friction clutch (300).

2. Moving assembly according to claim 1, characterized in that each arm (240, 241) of the control lever (20) bears a projecting shoe (100) which is externally configured to form a cam (101, 102, 103) which can come into contact with the casing (112, 113, 114) to move the latter axially towards the advanced position and in that the engaging means (200-200A, 120A) of the friction clutch (300) are connected to the control lever (20) and are configured to act on the drive element (118) in a delayed manner and press the latter in the direction of the reaction plate (112) to tighten the friction clutch (300).

3. Moving assembly according to claim 1, characterized in that the casing (112, 113, 114) bears projecting shoes which are externally configured to form a cam (101, 102, 103) each capable of coming into contact with an arm (240, 241) of the control lever (20) to move the casing (112, 113, 114) axially towards the advanced position and in that the engaging means (200-200A, 120A) of the friction clutch (300) are connected to the control lever (20) and are configured to act on the drive element (118) in a delayed manner and press the latter in the direction of the reaction plate (112) to tighten the friction clutch (300).

4. Moving assembly according to claim 1, characterized in that the engaging means (200) of the friction clutch (300) comprise an engaging member (200) for the friction clutch (300) which is attached to the lower extremity (240 to 242) of the control lever (20) and is configured to act on the drive element (118) and press the latter in the direction of the reaction plate (112) to tighten the friction clutch (300).

5. Moving assembly according to any on of claim 1, characterized in that the engaging means (200A, 120A) of the friction clutch comprise an additional lever (120A) which is configured to permit the control lever (20) to be mounted in an articulated way between the upper and lower extremities of the control lever (20) and in that the additional lever (120A) comprises an upper extremity (1244, 1245) which is capable of being moved after play has been taken up by manoeuvring means (2, 5a, 20a) forming part of a starter (4).

6. Moving assembly according to claim 5, characterized in that the additional lever (120A) comprises two flanges (1210, 1220) which match the shape of the control lever (20) located between these two flanges (1210, 1220) and in that these flanges (1210, 1220) are separated from each other between their upper and lower extremities by a cylindrical strut (1200) for articulated mounting of the control lever (20).

7. Moving assembly according to claim 5, characterized in that the engaging means (200A, 120A) of the friction clutch comprise an engaging member (200A) which is attached in an articulated way to the lower extremity (1240, 1241) of the additional lever (120A) and which is configured to act on the drive element in a delayed manner and press the latter in the direction of the reaction plate to tighten the clutch.

8. Moving assembly according to claim 1, characterized in that the casing (112, 113, 114) comprises a closing ring (114) and a skirt (113) connecting the reaction plate (112) to the closing ring (114) and that each projecting shoe (100) in the form of cam (101, 102, 103) is configured to come into contact with the closing ring (114) of the casing (112, 113, 114).

9. Moving assembly according to claim 1, characterized in that the casing (112, 113) has a connecting skirt (113) extending to the outer periphery of the reaction plate (112) directed in a direction opposite the pinion (11) and in that each projecting shoe (100) in the form of a cam (101, 102, 103) is configured to come into contact with the skirt (113) of the casing (112, 113).

10. Moving assembly according to claim 8, characterized in that each projecting shoe (100) in the form of a cam (101, 102, 103) comprises a summit portion (101) which is flat overall and capable of coming into contact with the closing ring (114) or the skirt (113) of the casing (112, 113, 114).

11. Moving assembly according to claim 10, characterized in that the lower extremity of the arm (240, 241) of the control lever (20) has a rounded portion (262) and in that each summit portion (101) is extended at its inner periphery by an inclined portion (102) extending in the direction of the flat portion (104) which is attached to the rounded portion (262).

12. Moving assembly according to claim 10, characterized in that the shoes (100) are intended to come into contact with the closing ring (114) or the skirt (113) via their summit portion (101) in two diametrically opposite areas of it.

13. Moving assembly according to claim 5, characterized in that the engaging member (200) of the clutch (300) is mounted in an articulated way on the fork-shaped lower extremity (240 to 242) of the lever (20) between the arms (240, 241) of this lower extremity.

14. Moving assembly according to claim 13, characterized in that the engaging member (200) comprises an engaging yoke mounted in an annular groove (223) of one piece with the drive element (118) and bounded by two sides.

15. Moving assembly according to claim 14, characterized in that the opening of the engaging yoke (200) is of oblong shape to permit radial displacement of the engaging yoke (200) in relation to the groove (223) and in that the engaging yoke (200) comprises two branches (201, 202) connected together through at least one outer portion (203).

16. Moving assembly according to claim 15, characterized in that the branches (201, 202) are separated from each other by a distance which overall corresponds to the outside diameter of the bottom of the groove (223).

17. Moving assembly according to claim 16, characterized in that each branch (201, 202) is mounted in an articulated manner on the lower extremity of an arm (240, 241) associated with the lever (20) and in that one of the branches (201, 202)/associated arm (240, 241) elements has a pivot (204) which penetrates a hole (261) forming part of the other of the associated arm (240, 241)/branch (201, 202) elements.

18. Moving assembly according to claim 17, characterized in that there is slight radial play between the pivot (204) and its associated hole (261).

19. Moving assembly according to claim 14, characterized in that the outside diameter of one (224) of the sides of the groove (223) is smaller than the inside diameter of the closing ring (114).

20. Assembly according to claim 19, characterized in that the drive element (118) comprises a drive bush (119) and in that the groove (223) is formed by means of an annular member (113) attached to the drive bush (119).

21. Moving assembly according to claim 1, characterized in that there is axial play (J) within the friction clutch (300) in the withdrawn resting position and in that a resilient washer (400) acting axially is placed between the reaction plate (112) and the drive element (118) to push the drive element (118) back towards the withdrawn resting position.

22. Moving assembly according to claim 21, characterized in that an engaging yoke (200) is capable of bearing on one of the sides (224) of the annular groove (223) in two diametrically opposite areas and in that the sides (224) are of a thickness which is greater than the axial play (J).

23. Moving assembly according to claim 21, characterized in that the resilient washer (400) is mounted in an annular groove (401) provided in the inner periphery of the reaction plate (112) and is open in the direction of the drive element (118).

24. Moving assembly according to claim 1, characterized in that the friction clutch (300) has at least one friction element (301) in the form of a friction disc (301) located between a pressure element in the form of a pressure plate (120) which is of one piece with the drive element (118) and the reaction plate (112) and in that the pressure plate comprises a flange (120) which is of one piece with the drive element (118).

25. Moving assembly according to claim 24, characterized in that the closing ring (114) is excavated on its inner periphery to form a shoulder which is capable of acting together with the rear surface of the flange (120).

26. Moving assembly according to claim 25, characterized in that the friction clutch (300) comprises two friction discs (301) which are of one piece in rotation with a front portion (121) of the drive element having axial mobility and alternately three friction discs (302) which are of one piece in rotation with the reaction plate (112) with axial mobility via the skirt (113) of the casing (112, 113, 114).

27. Starter (4) for a heat engine, in particular of a motor vehicle, characterized in that it comprises an output shaft (24) which is capable of being driven in rotation by an electric motor (M) and a starter drive unit (1) movably mounted on the output shaft (24) between a withdrawn resting position and an advanced position engaging with a starter toothed ring gear of the heat engine and in that the starter drive unit (1) forms part of a moving assembly according to claim 1.
